(19) United States
(12) Patent Application Publication
(10) Pub. No.: US 2025/0062322 A1
(43) Pub. Date: Feb. 20, 2025

(54) SILICON-CARBON COMPOSITE, METHOD FOR PREPARING SAME, AND NEGATIVE ELECTRODE ACTIVE MATERIAL FOR LITHIUM SECONDARY BATTERY COMPRISING SAME

(71) Applicant: DAEJOO ELECTRONIC MATERIALS CO., LTD., Gyeonggi-do (KR)

(72) Inventors: Heon Soo PARK, Gyeonggi-do (KR); Seung Min OH, Gyeonggi-do (KR); Dae Woon PARK, Gyeonggi-do (KR); Sung Soo KIM, Gyeonggi-do (KR); Seul Gi LEE, Gyeonggi-do (KR); Jong Chan LIM, Gyeonggi-do (KR)

(73) Assignee: DAEJOO ELECTRONIC MATERIALS CO., LTD., Gyeonggi-do (KR)

(21) Appl. No.: 18/713,868

(22) PCT Filed: Nov. 28, 2022
(86) PCT No.: PCT/KR2022/018976

§ 371 Date: May 28, 2024

(30) Foreign Application Priority Data
Nov. 29, 2021 (KR) 10-2021-0167717
Mar. 22, 2022 (KR) 10-2022-0035061

(51) Int. Cl. H01M 4/36; H01M 4/485; H01M 4/62; H01M 10/0525; H01M 10/42

(52) U.S. Cl. CPC H01M 4/366; H01M 4/485; H01M 4/625; H01M 4/628; H01M 10/0525; H01M 10/4235

(57) ABSTRACT

A silicon-carbon composite of the present invention comprises a lithium silicon composite oxide and carbon, wherein the lithium silicon composite oxide includes silicon particles, silicon oxide, magnesium silicate, and a lithium silicon compound. By comprising two or more carbon layers including a first carbon layer and a second carbon layer, the silicon-carbon composite can improve the performance of a secondary battery, such as slurry stability and initial charge/discharge characteristics, when used as a negative electrode active material of the secondary battery. In addition, the first carbon layer and the second carbon layer of the silicon-carbon composite satisfy specific thickness ranges, and thus, the silicon-carbon composite can further improve the performance of a secondary battery, such as capacity, cycle characteristics, and initial charge/discharge characteristics, when used as a negative electrode active material of the secondary battery.

### TECHNICAL FIELD

The present invention relates to a silicon-carbon composite, to a method for preparing the same, and to a negative electrode active material comprising the same for a lithium secondary battery.

### BACKGROUND ART

In recent years, as electronic devices become smaller, lighter, thinner, and more portable in tandem with the development of the information and communication industry, the demand for a high energy density of batteries used as power sources for these electronic devices is increasing. A lithium secondary battery is a battery that can best meet this demand, and research on small batteries using the same, as well as the application thereof to large electronic devices such as automobiles and power storage systems, is being actively conducted.

Carbon materials are widely used as a negative electrode active material for such a lithium secondary battery. Silicon-based negative electrode active materials are being studied in order to further enhance the capacity of batteries. Since the theoretical capacity of silicon (4,199 mAh/g) is greater than that of graphite (372 mAh/g) by 10 times or more, a significant enhancement in the battery capacity is expected.

However, when silicon is used as a main raw material as a negative electrode active material, the negative electrode active material expands or contracts during charging and discharging, and cracks may be formed on the surface or inside of the negative electrode active material. As a result, the reaction area of the negative electrode active material increases, the decomposition reaction of the electrolyte takes place, and a film is formed due to the decomposition product of the electrolyte during the decomposition reaction, which may cause a problem in that the cycle characteristics are deteriorated when it is applied to a secondary battery. Thus, attempts have continued to solve this problem.

Specifically, Japanese Laid-open Patent Publication No. 2001-185127 discloses a negative electrode active material containing a silicon oxide (SiOₓ) powder obtained by simultaneously depositing silicon and amorphous silicon dioxide to achieve excellent cycle characteristics and stability. The silicon oxide powder has a large electric capacity and can improve cycle characteristics, but has the problem of low initial efficiency.

To solve this problem, Japanese Laid-open Patent Publication No. 2014-188654 discloses a lithium-containing silicon oxide powder prepared by mixing a silicon oxide powder and a lithium raw material powder, calcining the mixture, and then coating the surface of the obtained powder with carbon. However, the lithium-containing silicon oxide powder thus prepared may cause the following two problems.

First, when lithium is doped into the particles of the silicon oxide powder, the lithium-containing silicon oxide powder may react in a solid phase on the surface of the particles. In such a case, the concentration of lithium doped within the particles may become non-uniform, and silicon crystals may grow excessively due to a rapid reaction, thereby deteriorating the characteristics of a secondary battery.

Second, the lithium-containing silicon oxide powder may have a serious problem in that when the lithium compound remaining on the surface of the lithium-doped silicon oxide powder and the lithium compound generated inside react with moisture during the production of an electrode slurry, gas is generated.

### PRIOR ART DOCUMENTS

### Patent Documents

(Patent Document 1) Japanese Laid-open Patent Publication No. 2001-185127
(Patent Document 2) Japanese Laid-open Patent Publication No. 2014-188654

### DISCLOSURE OF INVENTION

### Technical Problem

An object of the present invention is to provide a silicon-carbon composite that has excellent slurry stability in the manufacturing of secondary batteries and can comprehensively enhance the performance of secondary batteries by enhancing the initial charge and discharge efficiency, cycle characteristics, rapid charge and discharge characteristics, and capacity per weight of the secondary batteries.

Another object of the present invention is to provide a method for preparing the silicon-carbon composite.

Still another object of the present invention is to provide a negative electrode active material and a lithium secondary battery comprising the same, each of which comprises the silicon-carbon composite.

### Solution to Problem

The present invention provides a silicon-carbon composite that comprises a lithium silicon composite oxide and carbon, wherein the lithium silicon composite oxide comprises silicon particles, silicon oxide, magnesium silicate, and a lithium silicon compound, and the silicon-carbon composite comprises two or more carbon layers comprising a first carbon layer and a second carbon layer.

In addition, the present invention provides a silicon-carbon composite that comprises a lithium silicon composite oxide and carbon, wherein the lithium silicon composite oxide comprises silicon particles, silicon oxide, and a lithium silicon compound, the silicon-carbon composite comprises two or more carbon layers comprising a first carbon layer and a second carbon layer, the first carbon layer has a thickness of 10 nm to 200 nm, and the second carbon layer has a thickness of 10 nm to 2,000 nm.

In addition, the present invention provides a method for preparing a silicon-carbon composite that comprises step 1-1 of preparing a silicon composite oxide obtained using a silicon-based raw material and a magnesium-based raw material; step 1-2 of forming a first carbon layer on the surface of the silicon composite oxide; steps 1-3 of mixing the silicon composite oxide comprising the first carbon layer with a lithium source to obtain a lithium-containing mixture; steps 1-4 of heating the lithium-containing mixture in the presence of inert gas to obtain a silicon composite oxide doped with magnesium and lithium; and steps 1-5 of forming a second carbon layer on the surface of the silicon composite oxide doped with magnesium and lithium.

In addition, the present invention provides a method for preparing a silicon-carbon composite, which comprises step 2-1 of forming a first carbon layer on the surface of a silicon-based powder using chemical vapor deposition; step 2-2 of mixing the silicon-based powder comprising the first carbon layer with a lithium source to obtain a mixture; step 2-3 of calcining the mixture in the presence of inert gas to obtain a silicon composite doped with lithium; and steps 2-4 of forming a second carbon layer on the surface of the silicon composite doped with lithium using chemical vapor deposition.

In addition, the present invention provides a negative electrode active material for a lithium secondary battery that comprises the silicon-carbon composite.

Further, the present invention provides a lithium secondary battery that comprises the negative electrode active material for a lithium secondary battery.

### ADVANTAGEOUS EFFECTS OF INVENTION

According to an embodiment, as silicon particles, silicon oxide, magnesium silicate, and a lithium silicon compound are employed, two or more carbon layers are formed, and the doping amount of lithium and magnesium is adjusted, the slurry stability in the manufacturing of secondary batteries is excellent, and it is possible to comprehensively enhance the performance of secondary batteries by enhancing the initial charge and discharge efficiency, cycle characteristics, rapid charge and discharge characteristics, and capacity per weight of the secondary batteries in the use as a negative electrode active material.

According to another embodiment, as silicon particles, silicon oxide, and a lithium silicon compound are employed, two or more carbon layers are formed, and the thicknesses of the two or more carbon layers are adjusted to specific ranges, it is possible to comprehensively enhance the performance of secondary batteries by enhancing the capacity, cycle characteristics, and initial charge and discharge efficiency of the secondary batteries in the use as a negative electrode active material.

Further, secondary batteries comprising the silicon-carbon composite can obtain equivalent or better effects when used in electronic devices, power tools, electric vehicles, and power storage systems, and can be advantageously used in various fields.

### BRIEF DESCRIPTION OF DRAWINGS

FIG. 1 shows a schematic diagram that simplifies the cross-section of the structure of a silicon-carbon composite according to an embodiment of the present invention.

FIG. 2 shows a schematic diagram that simplifies the cross-section of the structure of a silicon-carbon composite according to another embodiment of the present invention.

FIG. 3 shows the measurement results of an X-ray diffraction analysis of the silicon-carbon composite of Example 1-1.

FIG. 4 shows the measurement results of an X-ray diffraction analysis of the silicon-carbon composite of Example 2-1.

FIG. 5 shows the measurement results of a Raman analysis of the silicon-carbon composite of Example 2-1.

FIG. 6 schematically shows the method of preparing a silicon-carbon composite according to an embodiment of the present invention.

FIG. 7 schematically shows the method of preparing a silicon-carbon composite according to another embodiment of the present invention.

### BEST MODE FOR CARRYING OUT THE INVENTION

The present invention is not limited to what is disclosed below. Rather, it may be modified in various forms as long as the gist of the invention is not altered.

In this specification, when a part is referred to as “comprising” an element, it is to be understood that the part may comprise other elements as well, unless otherwise indicated.

In this specification, singular expressions are interpreted to cover singular or plural as interpreted in context, unless otherwise specified.

In addition, all numbers and expressions related to the quantities of components, reaction conditions, and the like used herein should be understood as it can be modified by the term “about,” unless otherwise indicated.

Meanwhile, in this specification, such terms as first carbon layer, second carbon layer, or first and second are used to describe various components, and the components are not limited by the terms. The above terms are used only for the purpose of distinguishing one component from another.

In this specification, when one component is described as being formed on or under another component, it means that one component is formed directly on or under the other component, or indirectly through another component.

In addition, the size of each component in the drawings may be exaggerated for explanation and does not mean the actual size. In addition, the same reference numerals refer to the same elements throughout the specification.

### Silicon-Carbon Composite

The silicon-carbon composite according to an embodiment comprises a lithium silicon composite oxide and carbon, wherein the lithium silicon composite oxide comprises silicon particles, silicon oxide, magnesium silicate, and a lithium silicon compound, and the silicon-carbon composite comprises two or more carbon layers comprising a first carbon layer and a second carbon layer.

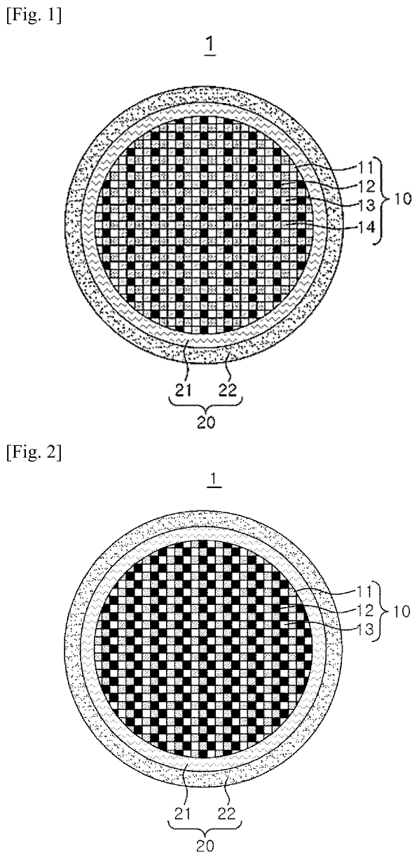

Specifically, referring to FIG. 1, the silicon-carbon composite (1) may comprise a lithium silicon composite oxide (10) comprising silicon particles (11), silicon oxide (12), magnesium silicate (14), and a lithium silicon compound (13), and the silicon-carbon composite comprises two or more carbon layers comprising a first carbon layer (21) and a second carbon layer (22) formed on the surface of the lithium silicon composite oxide (10).

According to an embodiment, the silicon-carbon composite comprises a lithium silicon composite oxide comprising silicon particles, silicon oxide, magnesium silicate, and a lithium silicon compound; and carbon, and two or more carbon layers are formed on the surface of the lithium silicon composite oxide. As a result, when used as a negative electrode active material for a secondary battery, excellent electrical conductivity can be achieved, and the electrical conductivity between the negative electrode and the current collector can be further enhanced, thereby enhancing the cycle characteristics of the secondary battery. In particular, as the doping amount of magnesium and lithium is adjusted, slurry stability can be enhanced, the crystallite size of silicon particles can be reduced, the pH can be lowered to a certain value or lower, and initial charge and discharge efficiency, rapid charge and discharge characteristics, and capacity per weight can be further enhanced.

Although a SiOₓ-based powder negative electrode material doped with lithium can improve the initial efficiency of an electrode, its activity against air, water, or other solvents increases, which aggravates handling convenience. When it is made into a slurry using a binder, if an aqueous binder is used, water as a solvent reacts with lithium. In addition, even when a polyimide, a non-aqueous binder, is used, the polyimide reacts with lithium. Thus, the stability of the slurry may decrease, which may cause cycle characteristics to deteriorate.

Since the reaction between a lithium source and SiOₓ is a surface reaction, a lot of highly active lithium remains on the surface of the SiOₓ doped with lithium. In the surface reaction between SiOₓ and lithium, lithium silicates such as Li₂SiO₃ and Li₂Si₂O₅, and Li—Si alloy are formed. They are all more active than SiOₓ, and they require caution when handling them in the air. Further, their elution and side reactions in an aqueous binder would cause problems in the current manufacturing process for an anode, and, in particular, they can cause deterioration of cycle characteristics.

On the other hand, magnesium silicates such as MgSiO₃ or Mg₂SiO₄, which are produced when SiOₓ is doped with magnesium, are very stable in water and organic solvents as compared with lithium silicon compounds. In addition, since they have lithium-ion conductivity higher than that of lithium silicon compounds, doping SiOₓ with magnesium suppresses the increase in irreversible capacity, enhances rapid charge and discharge characteristics, and ensures stability when slurried, whereby it may help enhance cycle characteristics.

However, when magnesium is doped, there is concern about the deterioration of cycle characteristics due to structural changes in the active material during charging and discharging. More specifically, since magnesium silicate may react with lithium during the charging and discharging procedure to decompose into magnesium oxide and lithium silicon compounds, the capacity characteristics may be lowered as compared with the case with lithium doping or without doping.

In order to simultaneously solve the problems of lithium doping and magnesium doping, a method of combining magnesium doping and lithium doping for SiOₓ-based powder may be used. When magnesium doping and lithium doping are used in combination, the capacity per weight increases relative to the case of doping with magnesium alone, and rapid charging and discharge characteristics are enhanced relative to the case of doping with lithium alone. In addition, the high reactivity to moisture or binder that occurs during lithium doping is compensated for through magnesium doping. Even doping with a relatively small amount of magnesium can effectively solve various problems caused by the high reactivity of lithium in the slurry-forming process. In addition, cycle characteristics can be enhanced relative to doping with lithium alone and doping with magnesium alone.

Accordingly, the silicon-carbon composite, which comprises both magnesium silicate and lithium silicon compounds, has excellent slurry stability in the manufacturing of secondary batteries and can comprehensively enhance the performance of secondary batteries by enhancing the initial charge and discharge efficiency, cycle characteristics, rapid charge and discharge characteristics, and capacity per weight of the secondary batteries.

In the silicon-carbon composite according to another embodiment, which comprises a lithium silicon composite oxide and carbon, the lithium silicon composite oxide comprises silicon particles, silicon oxide, and a lithium silicon compound, the silicon-carbon composite comprises two or more carbon layers comprising a first carbon layer and a second carbon layer, the first carbon layer has a thickness of 10 nm to 200 nm, and the second carbon layer has a thickness of 10 nm to 2,000 nm.

Specifically, referring to FIG. 2, the silicon-carbon composite (1) may comprise a lithium silicon composite oxide (10) comprising silicon particles (11), silicon oxide (12), and a lithium silicon compound (13); and the silicon-carbon composite comprises two or more carbon layers comprising a first carbon layer (21) and a second carbon layer (22) formed on the surface of the lithium silicon composite oxide (10).

The silicon-carbon composite of the present invention, according to an embodiment, comprises a lithium silicon composite oxide and carbon, the lithium silicon composite oxide comprising silicon particles, silicon oxide, and a lithium silicon compound, and it comprises two or more carbon layers formed on the surface of the lithium silicon composite oxide. Thus, when it is used as a negative electrode active material for a secondary battery, excellent electrical conductivity can be achieved, and the electrical conductivity between the negative electrode and the current collector can be further enhanced, thereby enhancing the cycle characteristics of the secondary battery. In particular, as the thicknesses of the two or more carbon layers are adjusted to specific ranges, it is possible to reduce the crystallite size of the silicon particles, to lower the pH to a certain value or lower, and to further enhance the discharge capacity and initial charge and discharge efficiency of a secondary battery.

Hereinafter, the constitution of the silicon-carbon composite will be described in detail.

### Lithium Silicon Composite Oxide

The silicon-carbon composite according to an embodiment of the present invention may comprise a lithium silicon composite oxide. The lithium silicon composite oxide may correspond to the core part of the silicon-carbon composite and may comprise silicon particles, silicon oxide, magnesium silicate, and a lithium silicon compound.

Specifically, the silicon-carbon composite may have a structure in which silicon particles, silicon oxide, magnesium silicate, and a lithium silicon compound are distributed, and they are firmly bonded to each other.

According to an embodiment of the present invention, the lithium silicon composite oxide may be a compound represented by the following General Formula 1-1:

LiₓMg_{y}SiO_{z} (x, y, and z are positive real numbers) [General Formula 1-1 ]

In General Formula 1-1, x, y, and z preferably satisfy the following Relationships (1) to (3).

$$0.8 \leq z \leq 1.2 \qquad ( 1 )$$

$$0.1 \leq x + y \leq 0.8 \qquad ( 2 )$$

$$0.1 \leq x / y \leq 2 \qquad ( 3 )$$

In General Formula 1-1, the content and molar ratio of each element may be values analyzed by an elemental analyzer, inductively coupled plasma (ICP) emission spectroscopy, or infrared absorption method.

In General Formula 1-1, x refers to the molar ratio of lithium to silicon, and y refers to the molar ratio of magnesium to silicon.

In General Formula 1-1, z refers to the molar ratio of oxygen to silicon. If the value of z is less than the above range, the secondary battery negative electrode material approaches Si, and its activity toward oxygen increases, whereby stability may decrease. If the value of z exceeds the above range, the production of inert oxides increases, which may reduce initial efficiency and deteriorate the performance of a secondary battery. More preferably, the value of z is 0.9 to 1.1, most preferably 0.95 to 1.05.

In addition, the value of x+y refers to the sum of the doping amounts of lithium and magnesium. If the value of x+y is less than the above range, the effect of lithium doping and magnesium doping is minimal. If the value of x+y exceeds the above range, a highly active Li—Si alloy or Mg—Si alloy is produced, which may cause handling problems. In addition, the reactivity with a slurry solvent and binder may be increased to deteriorate battery performance. More preferably, the value of x+y is 0.1 to 0.6, most preferably 0.2 to 0.5.

In addition, the value of x/y refers to the ratio of the lithium doping amount to the magnesium doping amount. If the value of x/y is less than the above range, the capacity per weight may decrease. If the value of x/y exceeds the above range, slurry stability may be reduced during preparation, or a Li—Si alloy may be formed to deteriorate the performance of a secondary battery. More preferably, the value of x/y is 0.15 to 1.8, most preferably 0.2 to less than 1.0.

Specifically, when the doping amounts of lithium and magnesium satisfy the above ranges, the capacity per weight is enhanced relative to the case of doping with magnesium alone, the chemical reaction of the binder is suppressed relative to the case of doping with lithium alone, which improves stability, and rapid charge and discharge characteristics and cycle characteristics can be enhanced.

In General Formula 1-1, the molar ratio of Li/Si (x) may be 0.05 to 0.3, preferably 0.1 to 0.25, more preferably 0.1 to 0.2.

In General Formula 1-1, the molar ratio of Mg/Si (y) may be 0.06 to 0.4, preferably 0.08 to 0.28, more preferably 0.1 to 0.22.

The porous silicon-carbon composite according to another embodiment may comprise silicon particles, silicon oxide, and a lithium silicon compound.

Specifically, the silicon-carbon composite may have a structure in which silicon particles, silicon oxide, and a lithium silicon compound are distributed, and they are firmly bonded to each other.

According to an embodiment of the present invention, the lithium silicon composite oxide may be a compound represented by the following General Formula 1-2:

LiₓSiO_{y} (0.05<x<1.0, 0.5<y<1.5, and x<y) [General Formula 1-2 ]

In General Formula 1-2, if the value of x is 0.05 or less, the lithium (Li) doping effect cannot be sufficiently obtained. If the value of x is 1.0 or more, a Li—Si alloy is formed in the silicon-carbon composite, which may deteriorate the performance of a secondary battery.

If the value of y is 0.5 or less, the expansion and/or contraction of the negative electrode active material may increase during the charging and discharging of a secondary battery, which reduces the lifespan characteristics of the secondary battery. If the value of y is 1.5 or more, the production of inert oxides increases, which may reduce the charge and discharge capacity of a secondary battery.

Specifically, in General Formula 1-2, x may be 0.05<x<0.7, and y may be 0.9<y<1.1. In General Formula 1-2, when the values of x and y each satisfy the above ranges, the expansion and/or contraction of the negative electrode active material is minimized during the charging and discharging of a secondary battery, whereby it is possible to enhance the lifespan characteristics and charge and discharge capacity of the secondary battery.

In General Formula 1-2, each element ratio may be measured by inductively coupled plasma (ICP) emission spectroscopy and infrared absorption method.

### Silicon Particles

The silicon-carbon composite according to an embodiment of the present invention comprises silicon particles, and the silicon particles as an active material may serve to charge lithium.

If the silicon-carbon composite does not comprise the silicon particles, the capacity of a secondary battery may decrease.

The silicon particles may be crystalline or amorphous and specifically may be amorphous or in a similar phase thereto.

If the silicon particles are crystalline, a dense composite may be obtained as the size of the crystallites is small, which fortifies the strength of the matrix to prevent cracks. Thus, the initial efficiency or cycle lifespan characteristics of a secondary battery can be further enhanced.

In addition, if the silicon particles are amorphous or in a similar phase thereto, the expansion or contraction during the charging and discharging of a secondary battery is reduced, and the performance of the secondary battery such as capacity characteristics can be further enhanced.

According to an embodiment of the present invention, it is preferable that the silicon particles are uniformly distributed within the lithium silicon composite oxide in the silicon-carbon composite. In such a case, excellent electrochemical properties such as charging and discharging can be exhibited, excellent mechanical properties such as strength can be obtained, and the volume expansion of silicon particles, if occurs, can be effectively alleviated and suppressed.

The silicon particles may comprise crystalline particles, and the silicon particles may have a crystallite size of 2 nm to 15 nm in an X-ray diffraction analysis.

Specifically, when the silicon-carbon composite according to an embodiment of the present invention is subjected to an X-ray diffraction (Cu-Kα) analysis using copper as a cathode target and calculated by the Scherrer equation based on a full width at half maximum (FWHM) of the diffraction peak of Si (220) around 20=47.5°, the silicon particles may preferably have a crystallite size of 4 nm to 10 nm, more preferably, 4 nm to 8 nm.

If the crystallite size of the silicon particles is less than the above range, it is difficult to form micropores in the lithium silicon composite oxide, and the Coulombic efficiency, which stands for the ratio of charge capacity to discharge capacity, may be reduced. In addition, if the crystallite size of the silicon particles exceeds the above range, the micropores cannot adequately suppress the volume expansion of silicon particles as an active material that may take place during charging and discharging, lifespan characteristics may rapidly deteriorate due to repeated charging and discharging, and the Coulombic efficiency, which stands for the ratio of charge capacity to discharge capacity, may be reduced.

As the silicon particles as an active material are made smaller to be pulverized, a denser composite can be obtained, which can enhance the strength of the matrix. Accordingly, in such a case, the performance of a secondary battery such as discharge capacity, initial efficiency, or cycle lifespan characteristics can be further enhanced.

In addition, the silicon-carbon composite may further comprise amorphous silicon or silicon in a similar phase thereto.

Although the silicon particles have high initial efficiency and battery capacity, it is accompanied by a very complex crystal change by electrochemically absorbing, storing, and releasing lithium atoms.

Meanwhile, in the silicon-carbon composite, the content of silicon (Si) in the silicon-carbon composite may be 30% by weight to 60% by weight, preferably, 30% by weight to 55% by weight, more preferably, 44% by weight to 50% by weight, based on the total weight of the silicon-carbon composite.

If the content of silicon (Si) is less than the above range, the amount of an active material for occlusion and release of lithium is small, which may reduce the charge and discharge capacity of a secondary battery. On the other hand, if the content of silicon (Si) exceeds the above range, the charge and discharge capacity of a secondary battery may be increased, whereas the expansion and contraction of the electrode during charging and discharging may be excessively increased, and the negative electrode active material powder may be further pulverized, which may deteriorate the cycle characteristics.

### Silicon Oxide

The silicon-carbon composite according to an embodiment of the present invention comprises silicon oxide (also referred to as a silicon oxide compound), thereby enhancing capacity and lifespan characteristics and reducing volume expansion when applied to secondary batteries. In particular, as the silicon oxide is uniformly distributed together with the silicon particles and a lithium silicon compound, expansion due to, for example, Li—Si alloying can be suppressed.

The silicon oxide may be a generic term for an amorphous silicon compound obtained by cooling and precipitation of silicon monoxide gas formed by the oxidation of metal silicon, the reduction of silicon dioxide, or heating a mixture of silicon dioxide and metal silicon. It may comprise a silicon oxide compound represented by the following General Formula 2.

$$Si {O}_{x} ( 0.4 \leq x \leq 2 ) \qquad [ General Formula 2 ]$$

In General Formula 2, x may preferably be 0.6≤x<1.6, more preferably, 0.9≤x<1.2.

In General Formula 2, if the value of x is less than the above range, the expansion and contraction of the negative electrode active material may be increased, and lifespan characteristics may be deteriorated, during the charging and discharging of a lithium secondary battery. In addition, if the value of x exceeds the above range, there may be a problem in that the initial efficiency of a secondary battery is decreased as the amount of inactive oxides increases.

In addition, if the silicon oxide comprises, for example, a lower silicon oxide powder of SiOₓ (0.9≤x<1.2), when applied to a secondary battery, volume expansion can be alleviated to further enhance the cycle characteristics of a secondary battery.

Meanwhile, the content of oxygen (O) in the silicon-carbon composite may be 1% by weight to 40% by weight, 10% by weight to 35% by weight, 20% by weight to 30% by weight, or 25% by weight to 35% by weight, based on the total weight of the silicon-carbon composite.

### Magnesium Silicate

The silicon-carbon composite according to an embodiment of the present invention may comprise magnesium silicate.

As the silicon-carbon composite comprises magnesium silicate, slurry stability is excellent when a secondary battery is manufactured, and capacity retention rate, rapid charge and discharge characteristics, and cycle characteristics can be enhanced when it is applied to a secondary battery.

Since magnesium silicate hardly reacts with lithium ions during the charging and discharging of a secondary battery, it is possible to reduce the expansion and contraction of the electrode when lithium ions are occluded in the electrode, thereby enhancing the cycle characteristics of the secondary battery. In addition, the strength of the matrix, which is a continuous phase surrounding the silicon, can be fortified by the magnesium silicate.

The magnesium silicate may be represented by the following General Formula 3:

MgₓSiO_{y} [General Formula 3]

In General Formula 3, x is 0.5≤x ≤2, and y is 2.5≤y≤4.

The magnesium silicate may comprise at least one selected from MgSiO₃ and Mg₂SiO₄.

Specifically, the magnesium silicate may comprise at least one selected from MgSiO₃ crystals (enstatite) and Mg₂SiO₄ crystals (forsterite).

In addition, according to an embodiment, the magnesium silicate may comprise MgSiO₃ crystals and may further comprise Mg₂SiO₄ crystals.

When the magnesium silicate comprises a mixture of MgSiO₃ crystals and Mg₂SiO₄ crystals, the ratio of MgSiO₃ crystals and Mg₂SiO₄ crystals may vary depending on the amount of magnesium employed in the raw material step.

In addition, the magnesium silicate may comprise substantially a large amount of MgSiO₃ crystals in order to enhance the Coulombic efficiency, charge and discharge capacity, initial efficiency, and capacity retention rate.

In the present specification, the phrase “comprising substantially a large amount of” a component may mean to comprise the component as a main component or mainly comprise the component.

Specifically, according to an embodiment, the magnesium silicate comprises MgSiO₃ crystals and further comprises Mg₂SiO₄ crystals. In such an event, in an X-ray diffraction analysis, the ratio IF/IE of an intensity (IF) of the X-ray diffraction peak corresponding to Mg₂SiO₄ crystals appearing in the range of 2θ=22.3° to 23.3° to an intensity (IE) of the X-ray diffraction peak corresponding to MgSiO₃ crystals appearing in the range of 2θ=30.5° to 31.5° may be 0.5 or more.

In the magnesium silicate, the content of magnesium relative to SiOₓ may have an impact on the initial discharge characteristics or cycle characteristics during charging and discharging. Specifically, if MgSiO₃ crystals are employed in the magnesium silicate in a substantially large amount, the improvement effect of the cycle during charging and discharging may be increased.

If the magnesium silicate comprises MgSiO₃ crystals and Mg₂SiO₄ crystals together, the initial efficiency may be enhanced. If Mg₂SiO₄ crystals are employed more than MgSiO₃ crystals, the degree of alloying of silicon with lithium atoms is lowered, whereby the initial discharge characteristics may be deteriorated.

According to an embodiment of the present invention, if the silicon-carbon composite comprises MgSiO₃ crystals and Mg₂SiO₄ crystals together, the initial efficiency can be further enhanced.

If the silicon-carbon composite comprises MgSiO₃ crystals, the MgSiO₃ crystals (e.g., a specific gravity of 2.7 g/cm³) have a smaller change in volume based on the change of volume of silicon (e.g., a specific gravity of 2.33 g/cm³), as compared with Mg₂SiO₄ crystals (e.g., a specific gravity of 3.2 g/cm³); thus, the cycle characteristics of a secondary battery can be further enhanced. In addition, the MgSiO₃ crystals and Mg₂SiO₄ crystals may act as a diluent or inert material in a negative electrode active material. In addition, if MgSiO₃ crystals are formed, the pulverization caused by the contraction and expansion of silicon is suppressed, whereby the initial efficiency can be enhanced.

In addition, the magnesium silicate hardly reacts with lithium ions; thus, when it is contained in an electrode, it is possible to reduce the contraction and expansion of the electrode when lithium ions are occluded and to enhance the cycle characteristics.

In addition, the strength of the matrix, which is a continuous phase surrounding the silicon, can be fortified by magnesium silicate.

As the silicon-carbon composite comprises magnesium silicate, a chemical reaction between the negative electrode material and the binder may be suppressed, slurry stability may be improved, and the stability and cycle characteristics of the negative electrode may be improved together during the manufacture of a lithium secondary battery, relative to the case of doping with lithium alone.

In addition, when the magnesium silicate comprises both MgSiO₃ crystals and Mg₂SiO₄ crystals, it is preferable that the MgSiO₃ crystals and Mg₂SiO₄ crystals are uniformly dispersed in the core. It is preferable that the crystallite size thereof is 10 nm or less.

When the MgSiO₃ crystals and Mg₂SiO₄ crystals are uniformly dispersed, the silicon particles and the constituent elements of the MgSiO₃ crystal and the Mg₂SiO₄ crystal are diffused with each other, and the phase interface is in a bonded state, that is, each phase is in a bonded state at the atomic level; thus, the change in volume may be small when lithium ions are occluded and released, and cracks may be hardly formed in the negative electrode active material even by repeated charging and discharging. Thus, deterioration in the capacity would hardly take place even with a high number of cycles.

Meanwhile, the total content (doping amount) of magnesium contained in the silicon-carbon composite may be 3% by weight to 15% by weight, preferably, 4% by weight to 12% by weight, more preferably, 5% by weight to 10% by weight, based on the total weight of the silicon-carbon composite.

### Lithium Silicon Compound

The silicon-carbon composite according to an embodiment of the present invention comprises a lithium silicon compound (lithium silicate).

As the silicon-carbon composite comprises a lithium silicon compound, the capacity characteristics and initial efficiency of a secondary battery can be enhanced.

The lithium silicon compound may comprise at least one selected from Li₂SiO₃. Li₂Si₂O₅, and Li₄SiO₄, or at least one selected from Li₂SiO₃ and Li₂Si₂O₅. As the lithium silicon compound is employed, there may be the advantage of enhancing the initial efficiency of a secondary battery and suppressing volume expansion.

In particular, when the lithium silicon compound comprises Li₂Si₂O₅, the stability of a slurry used in the preparation of an electrode and the cycle characteristics of a secondary battery can be further enhanced.

Meanwhile, the structure of the lithium silicon compound may vary depending on the total content (doping amount) of lithium (Li) contained in the silicon-carbon composite and the doping method of lithium.

The total content (doping amount) of lithium (Li) contained in the silicon-carbon composite may be 1% by weight to 10% by weight, 2% by weight to 10% by weight, 3% by weight to 9% by weight, or 3% by weight to 8% by weight, based on the total weight of the silicon-carbon composite.

In addition, the total content (doping amount) of lithium (Li) contained in the silicon-carbon composite may be 1% by weight to 6% by weight, 2% by weight to 5% by weight, or 2% by weight to 4% by weight, based on the total weight of the silicon-carbon composite.

If the total content of lithium (Li) is less than the above range, the effect of doping with lithium may be insignificant. If the total content of lithium (Li) exceeds the above range, inert oxides may increase, thereby decreasing charge and discharge capacity.

The doping with lithium may be carried out by forming a first carbon layer on the surface of a silicon composite oxide, which is a raw material used in the preparation of the silicon-carbon composite, and then mixing the silicon composite oxide comprising the first carbon layer with a lithium source, followed by heating thereof. In such a case, it may be more advantageous for forming a lithium silicon compound such as Li₂Si₂O₅. In addition, when lithium is doped once a first carbon layer has been formed on the surface of the silicon composite oxide, it is possible to solve conventional problems such as uneven concentration of doped lithium, excessive growth of silicon crystals, and lithium source remaining on the surface of the silicon composite oxide, which causes various problems such as deterioration of cycle characteristics and deterioration during repeated charging and discharging, while further enhancing the performance of a secondary battery.

As the silicon-carbon composite comprises a lithium silicon compound, it is possible to enhance the capacity per weight of a secondary battery by reducing the doping amount of magnesium and to improve cycle characteristics, as compared with the case of doping with magnesium alone.

Meanwhile, the content of the lithium silicon compound may be 1% by weight to 10% by weight, 2% by weight to 10% by weight, 3% by weight to 9% by weight, 3% by weight to 8% by weight, 1% by weight to 6% by weight, 2% by weight to 5% by weight, or 2% by weight to 4% by weight, based on the total weight of the silicon-carbon composite. When the content of the lithium silicon compound satisfies the above range, the initial efficiency and volume expansion suppression effect of a secondary battery can be further enhanced. If the content of the lithium silicon compound is less than the above range, there may be difficulties in achieving the desired effect of the present invention. If it exceeds the above range, the stability of a slurry may be deteriorated.

### Carbon

As the silicon-carbon composite according to an embodiment of the present invention comprises carbon, it is possible to impart conductivity and further enhance the performance of a secondary battery.

The carbon may be present on the surface of the lithium silicon composite oxide contained in the silicon-carbon composite, or both on the surface and inside of the lithium silicon composite oxide.

Specifically, the silicon-carbon composite comprises two or more carbon layers comprising a first carbon layer and a second carbon layer on the surface of the lithium silicon composite oxide comprising the silicon particles, silicon oxide, and lithium silicon compound, and the carbon may be contained in the carbon layers.

Alternatively, the silicon-carbon composite comprises two or more carbon layers comprising a first carbon layer and a second carbon layer on the surface of the lithium silicon composite oxide comprising the silicon particles, silicon oxide, magnesium silicate, and lithium silicon compound, and the carbon may be contained in the carbon layers.

According to an embodiment of the present invention, as the silicon-carbon composite comprises two or more carbon layers comprising a first carbon layer and a second carbon layer, the performance of a secondary battery can be further enhanced.

Specifically, in the silicon-carbon composite, the first carbon layer may be a conductive carbon layer that imparts conductivity, and the second carbon layer may be a reaction inhibition layer that reduces reactivity with the electrolyte solution of a secondary battery when the silicon-carbon composite is applied to the secondary battery. That is, the silicon-carbon composite comprises a first carbon layer that can impart conductivity to the surface of the lithium silicon composite oxide and facilitate uniform coating to minimize surface exposure of the active material particles; and a second carbon layer formed on the first carbon layer to suppress reactivity with the electrolyte and reduce the specific surface area. As a result, it is possible to impart conductivity while suppressing reactivity with the electrolyte solution at the same time, thereby significantly enhancing the cycle characteristics and high-temperature storage preservation of a secondary battery. In addition, the concentration distribution of magnesium and lithium doped in the silicon-carbon composite can be uniformized, thereby minimizing the phenomenon of local increase in reactivity. When an aqueous slurry is prepared, the elution of the lithium silicon compound and the infiltration of moisture can be suppressed. As a result, the viscosity change of the slurry and gas generation are suppressed, thereby further enhancing production stability.

In addition, the carbon may be contained both on the surface and inside of the lithium silicon composite oxide.

Specifically, the carbon is contained in the first carbon layer and the second carbon layer on the surface of the lithium silicon composite oxide, and is uniformly distributed together with the silicon particles, silicon oxide, and lithium silicon compound, or is formed surrounded by each surface thereof.

In addition, the carbon is contained in the first carbon layer and the second carbon layer on the surface of the lithium silicon composite oxide, and is uniformly distributed together with the silicon particles, silicon oxide, magnesium silicate, and lithium silicon compound, or is formed surrounded by each surface thereof.

Specifically, the carbon may be present on part or all of the surface of the silicon particles, silicon oxide, magnesium silicate, and/or lithium silicon compound contained in the silicon-carbon composite. In addition, the carbon may be present on part or all of the surface of the silicon aggregates contained in the silicon-carbon composite. In addition, the carbon may be distributed between the silicon particles, silicon oxide, magnesium silicate, and/or lithium silicon compound.

Meanwhile, according to an embodiment of the present invention, it is important to control the respective thicknesses of the first carbon layer and the second carbon layer to specific ranges.

The thickness of the first carbon layer may be 10 nm to 200 nm, 30 nm to 150 nm, 50 nm to 150 nm, or 40 nm to 120 nm.

If the thickness of the first carbon layer is less than the above range, it is not easy to control the uniformity of the first carbon layer and the crystallinity of the coating film; thus, there may be a problem of reduction in initial efficiency and capacity. In addition, there may be difficulties in achieving uniformity in the concentration distribution of doped lithium, which may cause reactivity to increase locally, and the effect of suppressing the volume change of the silicon particles may be minimal. In addition, if the thickness of the first carbon layer exceeds the above range, there may be a problem of increased resistance that impedes the mobility of lithium ions.

The thickness of the second carbon layer may be 10 nm to 2,000 nm, 10 nm to 1,500 nm, 10 to 1,000 nm, 10 to 500 nm, 30 to 200 nm, or 30 to 150 nm.

If the thickness of the second carbon layer satisfies the above range, the capacity characteristics of a secondary battery can be further enhanced. If the thickness of the second carbon layer is less than the above range, the effect of suppressing reactivity with the electrolyte solution may be minimal. If it exceeds the above range, the carbon content of the second carbon layer is excessive, which may decrease the capacity of a secondary battery, and the mobility of lithium ions may be impaired, which may increase resistance.

When the respective thicknesses of the first carbon layer and the second carbon layer satisfy the above ranges, it is possible to suppress reactivity with the electrolyte solution while imparting conductivity and to effectively prevent or alleviate side effects between the silicon particles and electrolyte due to intercalation and detachment of lithium; thus, the cycle characteristics and initial charge and discharge efficiency of a secondary battery can be enhanced. In addition, when an aqueous slurry is prepared, the elution of lithium and lithium silicon compounds and the infiltration of moisture can be suppressed. As a result, the viscosity change of the slurry and gas generation are suppressed, thereby further enhancing production stability.

The thickness of the carbon layer may be measured, for example, by the following procedure.

First, a negative electrode active material is observed at an arbitrary magnification by a transmission electron microscope (TEM). The magnification is preferably, for example, a degree that can be confirmed with the naked eye. Subsequently, the thickness of the carbon layer is measured at arbitrary 15 points. In such an event, it is preferable to select the measurement positions at random widely as much as possible, without concentrating on a specific region. Finally, the average value of the thicknesses of the carbon layer at the 15 points is calculated.

According to an embodiment of the present invention, the ratio of the thickness of the first carbon layer and the thickness of the second carbon layer may be 1:0.05 to 200, preferably 1:0.2 to 50, more preferably 1:0.5 to 4. When the ratio of the thickness of the first carbon layer and the thickness of the second carbon layer satisfies the above range, the effect of imparting conductivity and suppressing reactivity with the electrolyte solution is appropriately achieved, whereby the performance of a secondary battery can be further enhanced.

The first carbon layer and the second carbon layer may each comprise at least one selected from the group consisting of amorphous carbon, crystalline carbon, graphene, reduced graphene oxide, a carbon nanotube, a carbon nanofiber, and graphite.

The amorphous carbon may comprise at least one selected from the group consisting of soft carbon (low-temperature calcined carbon), hard carbon, pitch carbide, mesophase pitch carbide, and calcined coke.

The types of the first carbon layer and the second carbon layer may be different from each other.

Meanwhile, the content of carbon (C) in the silicon-carbon composite may be 2% by weight to 30% by weight, preferably, 3% by weight to 20% by weight, more preferably, 4% by weight to 15% by weight, based on the total weight of the silicon-carbon composite.

When the content of carbon (C) satisfies the above range, two or more layers of carbon can be uniformly formed on the surface of the lithium silicon composite oxide, and the initial efficiency and life characteristics of a secondary battery can be effectively improved.

If the content of carbon (C) is less than the above range, a sufficient effect of enhancing conductivity cannot be expected, and there is a concern that the lifespan of a secondary battery may be deteriorated. In addition, if the content of carbon (C) exceeds the above range, the discharge capacity may decrease, making it difficult to obtain high energy, and the bulk density may decrease, thereby reducing the charge and discharge capacity per unit volume.

In addition, the amount of carbon (C) contained in the first carbon layer may be 1% by weight to 12% by weight, preferably, 2% by weight to 8% by weight, more preferably, 3% by weight to 6% by weight, based on the total weight of the silicon-carbon composite. When the amount of carbon (C) contained in the first carbon layer satisfies the above range, the uniformity of lithium doping can be enhanced while imparting conductivity.

The amount of carbon (C) contained in the second carbon layer may be 1% by weight to 19% by weight, preferably, 1% by weight to 12% by weight, more preferably, 1% by weight to 7% by weight, based on the total weight of the silicon-carbon composite.

When the amount of carbon (C) in the first carbon layer, the amount of carbon (C) in the second carbon layer, the total content of carbon (C), or the total thickness of the carbon layers satisfies the above range, it is possible to maintain conductive paths between the respective carbon layers, thereby suppressing the surface oxidation of the lithium silicon composite oxide and to enhance the electrical conductivity of a secondary battery, thereby enhancing the capacity characteristics and cycle characteristics of the secondary battery. In addition, when an aqueous slurry is prepared, the elution of lithium silicon compound and the infiltration of moisture can be suppressed. As a result, the viscosity change of the binder and gas generation are suppressed, thereby further enhancing production stability.

If the amount of carbon (C) in the first carbon layer, the amount of carbon (C) in the second carbon layer, the total content of carbon (C), or the total thickness of the carbon layers does not satisfy the above range, the initial efficiency of a secondary battery may decrease.

According to an embodiment of the present invention, as the silicon-carbon composite comprises two or more carbon layers comprising a first carbon layer and a second carbon layer, the pH is lowered, and discharge capacity and initial charge and discharge efficiency can be enhanced.

The silicon-carbon composite may have a pH of 7.5 to less than 11.5, preferably, 7.5 to less than 11.3, more preferably, 7.5 to less than 11.0. When the pH satisfies the above range, the low pH minimizes the generation of hydrogen gas due to the reaction between silicon and water, thereby enhancing slurry stability and enhancing initial efficiency and cycle characteristics. The pH of the silicon-carbon composite may be measured using a pH meter, for example, using HM-30P Model of TOADKK.

Meanwhile, the silicon-carbon composite according to an embodiment of the present invention may have a specific gravity of 2.3 g/cm³ to 2.6 g/cm³, preferably, 2.3 g/cm³ to 2.55 g/cm³, more preferably, 2.35 g/cm³ to 2.5 g/cm³. Here, specific gravity may refer to particle density, density, or true density.

When the specific gravity of the silicon-carbon composite satisfies the above range, a negative electrode active material in which lithium is appropriately doped (intercalated) in the silicon-carbon composite powder can be provided; thus, it may be more advantageous for achieving the effects desired in the present invention. Specifically, when the specific gravity of the silicon-carbon composite satisfies the above range, the characteristics of a secondary battery can be more stabilized, and the production of lithium silicon compounds is not excessive; thus, it is possible to suppress reduction in the diffusion of lithium inside the silicon-carbon composite.

The specific gravity may be measured using a commonly used method. For example, a measurement method using a gas substitution method using helium gas may be used. As a measuring device, a fully automatic true density measuring device (for example, Macpycno) manufactured by Mountec may be used.

In addition, according to an embodiment of the present invention, for the measurement of specific gravity, for example, for the measurement of specific gravity by a dry density meter, Acupick II1340 manufactured by Shimadzu Corporation may be used as a dry density meter. The purge gas to be used may be helium gas, and the measurement may be carried out after 200 times of purge in a sample holder set at a temperature of 23° C.

Meanwhile, the silicon-carbon composite may have an average particle diameter (_{D50}) of 2 μm to 15 μm, preferably, 2 μm to 10 μm, more preferably, 3 μm to 10 μm.

The average particle diameter (_{D50}) is a value measured as a diameter average value (_{D50}), i.e., a particle size or median diameter when the cumulative volume is 50% in particle size distribution measurement according to a laser beam diffraction method. When the average particle diameter (_{D50}) of the silicon-carbon composite satisfies the above range, lithium ions are readily occluded and released during the charging and discharging of a secondary battery, and the occurrence of cracks in the silicon-carbon composite can be reduced. In addition, the surface area per mass can be reduced, the increase in irreversible capacity of the secondary battery can be suppressed, and the reaction with the electrolyte solution can be suppressed; thus, the characteristics of the secondary battery can be enhanced.

Meanwhile, the silicon-carbon composite may have a specific surface area (Brunauer-Emmett-Teller; BET) of 1 m^{2/}g to 20 m²/g, preferably, 1 m²/g to 15 m²/g, more preferably, 1 m²/g to 10 m²/g. If the specific surface area of the silicon-carbon composite is less than the above range, cycle characteristics may be deteriorated when charging and discharging is repeated. If it exceeds the above range, the amount of solvent absorbed may increase during the preparation of an electrode, which may require the addition of an excessive amount of a binder. In such a case, conductivity may decrease, and cycle characteristics may deteriorate. The specific surface area can be measured by the BET one-point method by nitrogen adsorption.

### Method for Preparing a Silicon-Carbon Composite

According to an embodiment of the present invention, there is provided a method for preparing the silicon-carbon composite.

Combined doping of magnesium and lithium may be carried out through the following method.

As a first doping method, a SiOₓ-based powder and a magnesium-based raw material are doped using a chemical vapor deposition (CVD) method to produce a composite oxide, and a first carbon layer is then formed on the powder by a CVD method. In addition, lithium is doped, and a second carbon layer is formed by a CVD method to prepare a silicon-carbon composite.

As a second doping method, a SiOₓ-based powder is doped with magnesium, and the powder is further doped with lithium. Specifically, a SiOₓ-based powder and a powdered magnesium source are mixed and heated, and a lithium source is then mixed with the powder, which is heated to obtain a composite oxide powder (composite powder A). Alternatively, a SiOₓ-based powder is electrochemically doped with magnesium, and the powder is then electrochemically doped with lithium to prepare a composite oxide powder (composite powder B). Next, first and second carbon layers with different thicknesses of carbon layer are formed on composite powder A or composite powder B to obtain a silicon-carbon composite. The formation of the two carbon layers is preferably carried out by a CVD method.

As a third doping method, a SiOₓ-based powder is doped with lithium, and a first carbon layer is formed by a CVD method. The composite oxide powder is further doped with magnesium, and a second carbon layer is then formed by a CVD method to prepare a silicon-carbon composite. Specifically, a SiOₓ-based powder and a powdered lithium source are mixed and heated, and a first carbon layer is formed on the powder by a CVD method, which is mixed with a powdered magnesium source and heated. Next, a second carbon layer is formed on the composite oxide powder mixed with a magnesium source and heated by a CVD method to obtain a silicon-carbon composite.

In some cases, when the powder is doped with lithium or magnesium, the doping may be carried out electrochemically.

As a fourth doping method, a SiOₓ-based powder is doped with lithium, and the powder is further doped with magnesium. Specifically, a SiOₓ-based powder and a powdered lithium source are mixed and heated to prepare a composite oxide powder (composite powder C). The powder is mixed with a powdered magnesium source and heated to prepare a composite oxide powder (composite powder D). Alternatively, a SiOₓ-based powder is doped with lithium electrochemically to prepare a composite oxide powder (composite powder E).

To form carbon layers, a first carbon layer is formed on composite powder C, composite powder D, or composite powder E, which is then mixed with a magnesium source and heated to form a second carbon layer on each composite powder.

As another method, first and second carbon layers with different thicknesses of carbon layer are formed on composite powder C, composite powder D, or composite powder E to obtain a silicon-carbon composite. The formation of the two carbon layers is preferably carried out by a CVD method.

As a fifth doping method, a SiOₓ-based powder is doped with lithium and magnesium at the same time. Specifically, a SiOₓ-based powder is mixed with a powdered lithium source and a powdered magnesium source and heated, or it may be carried out by a CVD method.

To form carbon layers, first and second carbon layers with different thicknesses of carbon layer are formed on the composite oxide powder doped with magnesium and lithium to obtain silicon-carbon composite. The formation of the two carbon layers is preferably carried out by a CVD method.

It is possible to prepare a SiOₓ-based powder negative electrode material using a combination of lithium doping and magnesium doping by any one of the above first to fifth doping methods. However, the first, second, or fifth doping method is preferable since it can enhance the capacity characteristics or cycle characteristics of a secondary battery.

A method for preparing a silicon-carbon composite using a representative doping method among the above methods is as follows.

Specifically, the method for preparing a silicon-carbon composite may comprise step 1-1 of preparing a silicon composite oxide obtained using a silicon-based raw material and a magnesium-based raw material; step 1-2 of forming a first carbon layer on the surface of the silicon composite oxide; step 1-3 of mixing the silicon composite oxide comprising the first carbon layer with a lithium source to obtain a lithium-containing mixture; step 1-4 of heating the lithium-containing mixture in the presence of inert gas to obtain a silicon composite oxide doped with magnesium and lithium; and step 1-5 of forming a second carbon layer on the surface of the silicon composite oxide doped with magnesium and lithium.

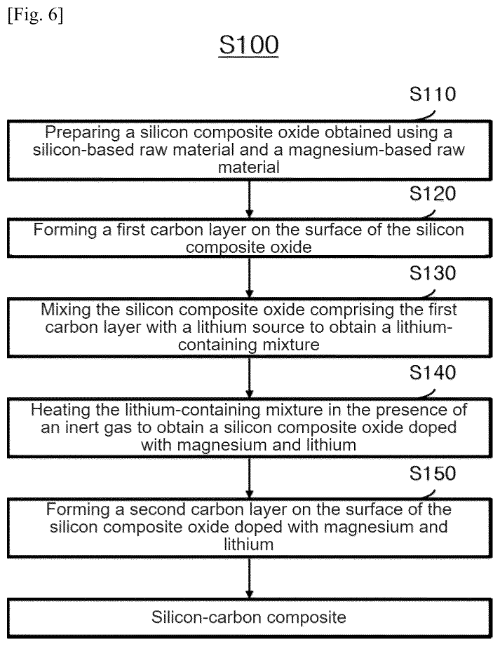

Referring to FIG. 6, in the method for preparing a silicon-carbon composite (S100), step 1-1 may comprise preparing a silicon composite oxide obtained using a silicon-based raw material and a magnesium-based raw material (S110). Step 1-1 may be carried out by, for example, using the method described in Korean Laid-open Patent Publication No. 2018-0106485.

The content of magnesium (Mg) in the silicon composite oxide obtained in step 1-1 may preferably be 3% by weight to 15% by weight, more preferably, 4% by weight to 10% by weight, even more preferably, 4% by weight to 8% by weight, based on the total weight of the silicon-carbon composite.

The silicon-based raw material may comprise a silicon-based powder.

Specifically, the silicon-based powder is a powder comprising silicon capable of reacting with lithium. For example, it may comprise at least one selected from silicon, silicon oxide, and silicon dioxide. Specifically, the silicon-based powder may comprise a lower silicon oxide powder represented by the General Formula of SiOₓ (0.9≤x<1.2).

The silicon-based powder may be amorphous or crystalline SiOₓ (crystallite size of silicon: about 2 to 3 nm) prepared by a gas phase method. The average particle diameter, as a median diameter, of the silicon-based powder may be about 0.5 to 30 μm, preferably, 0.5 to 25 μm, more preferably, 0.5 to 10 μm. If the average particle diameter of the silicon-based powder is less than the above range, the bulk density is too small, which reduces the charge and discharge capacity per unit volume. If the average particle diameter of the silicon-based powder exceeds the above range, it may be difficult to fabricate an electrode; thus, it may be delaminated from the current collector. The average particle diameter is a value measured as a diameter average value D₅₀ (i.e., a particle diameter when the cumulative weight is 50%) median diameter in particle size distribution measurement according to a laser beam diffraction method.

The magnesium-based raw material may comprise a powdered magnesium source.

The powdered magnesium source may comprise at least one selected from the group consisting of magnesium metal, magnesium hydride (MgH₂), magnesium oxide (MgO), magnesium hydroxide (Mg(OH)₂), and magnesium carbonate (MgCO₃).

In the method for preparing a silicon-carbon composite (S100), step 1-2 may comprise forming a first carbon layer on the surface of the silicon composite oxide (S120).

The step of forming a first carbon layer may be carried out using a chemical vapor deposition method.

The chemical vapor deposition method is a chemical pyrolysis deposition method, which may be carried out by injecting at least one carbon source gas selected from compounds represented by the following Formulae 1 to 3 and carrying out a reaction of the silicon composite oxide in a gaseous state at 400° C. to 1,200° C.

C_{N}H_{(2N+2-A)}[OH]_{A} [Formula 1]

in Formula 1, N is an integer of 1 to 20, and A is 0 or 1,

C_{N}H_{(2N-B)} [Formula 2]

in Formula 2, N is an integer of 2 to 6, and B is an integer of 0 to 2,

CₓH_{y}O_{z} [Formula 3]

in Formula 3, x is an integer of 1 to 20, y is an integer of 0 to 25, and z is an integer of 0 to 5.

The compound represented by Formula 1 may be at least one selected from the group consisting of methane, ethane, propane, butane, methanol, ethanol, propanol, propanediol, and butanediol. The compound represented by Formula 2 may be at least one selected from the group consisting of ethylene, acetylene, propylene, butylene, butadiene, and cyclopentene. The compound represented by Formula 3 may be at least one selected from the group consisting of benzene, toluene, xylene, ethylbenzene, naphthalene, anthracene, and dibutyl hydroxy toluene (BHT).

Preferably, the carbon source gas may be at least one selected from the group consisting of gases comprising methane, ethylene, acetylene, propane, and butane.

The amount of carbon (C) contained in the first carbon layer may be the amount of carbon coating in steps 1-2.

The amount of carbon (C) contained in the first carbon layer may be 0.5% by weight to 15% by weight, preferably, 2% by weight to 15% by weight, more preferably, 3% by weight to 10% by weight, based on the total weight of the silicon composite oxide.

When the amount of carbon (C) contained in the first carbon layer satisfies the above range, the surface of the silicon composite oxide can be uniformly coated with carbon. This is preferable since cycle lifespan and aqueous slurry stability are further enhanced.

The amount of carbon (C) contained in the first carbon layer may be adjusted to the above range by controlling the type of gas used, gas concentration, reaction temperature, reaction time, and the like.

The carbon source gas may further comprise at least one inert gas selected from hydrogen, nitrogen, helium, and argon.

The reaction may be carried out at, for example, 400° C. to 1,200° C., specifically, 650° C. to 1,100° C., more specifically, 650° C. to 900° C.

The reaction time (or thermal treatment time) may be appropriately adjusted depending on the thermal treatment temperature, the pressure during the thermal treatment, the composition of the gas mixture, and the desired amount of carbon to be contained in the first carbon layer. For example, the reaction time may be 10 minutes to 100 hours, specifically, 30 minutes to 90 hours, more specifically, 50 minutes to 40 hours, but it is not limited thereto.

In the method for preparing a silicon-carbon composite according to an embodiment of the present invention, it is possible to form a thin and uniform carbon layer comprising, for example, amorphous carbon, crystalline carbon, graphene, reduced graphene oxide, a carbon nanotube, a carbon nanofiber, or graphite as a main component on the surface of the silicon composite oxide even at a relatively low temperature through a gas-phase reaction of the carbon source gas. In addition, the detachment reaction in the carbon layer thus formed does not substantially take place.

In addition, the thickness of the first carbon layer may be controlled by changing the reaction temperature and time and by adjusting the flow rate of the carbon source and inert gas. For example, the carbon source gas may be supplied at a flow rate of 3 LPM to 20 LPM, specifically, 3 LPM to 15 LPM, more specifically, 3 LPM to 12 LPM, and the inert gas may be supplied at a flow rate of 4 LPM to 30 LPM, specifically, 4 LPM to 25 LPM, more specifically, 5 LPM to 20 LPM.

Meanwhile, when a carbon layer is uniformly formed over the entire surface of the silicon composite oxide through the gas-phase reaction, a carbon film (first carbon layer) having high crystallinity can be formed.

According to an embodiment of the present invention, when a reaction gas comprising the carbon source gas and an inert gas is supplied to the silicon composite oxide, the reaction gas may form a carbon layer comprising at least one selected from amorphous carbon, crystalline carbon, graphene, reduced graphene oxide, a carbon nanotube, a carbon nanofiber, and graphite on the surface of the silicon composite oxide. For example, as the reaction time elapses, the conductive carbon material deposited on the surface of the silicon composite oxide is gradually grown to obtain a silicon composite oxide comprising a first carbon layer.

The specific surface area of the silicon-carbon composite according to an embodiment of the present invention may decrease depending on the amount of carbon (C) contained in the first carbon layer.

In addition, according to an embodiment of the present invention, by virtue of the formation of the first carbon layer of the silicon-carbon composite, it is possible to suppress structural collapse due to the volume expansion of silicon particles and silicon oxide even if a binder is not used; and to provide an electrode and a lithium secondary battery having excellent electrical conductivity and capacity characteristics by minimizing an increase in resistance.

In addition, one or more of the silicon composite oxides may be connected to each other to form an aggregate. Thus, in order to prevent the formation of such aggregates, after the first carbon layer is formed in step 1-2, a step of pulverization and classification may be further carried out such that the final silicon-carbon composite may have an average particle diameter of 2 μm to 15 μm. The classification may be carried out to adjust the particle size distribution of the silicon composite oxide, for which dry classification, wet classification, or classification using a sieve may be used. In the dry classification, the steps of dispersion, separation, collection (separation of solids and gases), and discharge are carried out sequentially or simultaneously using an air stream, in which pretreatment (adjustment of moisture, dispersibility, humidity, and the like) may be carried out prior to the classification so as not to decrease the classification efficiency caused by interference between particles, particle shape, airflow disturbance, velocity distribution, and influence of static electricity, and the like, to thereby adjust the moisture or oxygen concentration in the air stream used. In addition, a desired particle size distribution may be obtained by carrying out pulverization and classification at one time. After the pulverization, it is effective to divide the coarse powder part and the granular part with a classifier or sieve.

In the method for preparing a silicon-carbon composite, step 1-3 may comprise mixing the silicon composite oxide comprising the first carbon layer with a lithium source to obtain a lithium-containing mixture (S130).

The lithium source may comprise at least one selected from the group consisting of lithium metal (Li), lithium hydride (LiH), lithium carbonate (Li₂CO₃), lithium hydroxide (LiOH), lithium nitride (Li₃N), and lithium oxide (Li₂O).

In addition, although the presence of a certain amount of oxygen in an inert gas atmosphere during the doping with lithium may help enhance initial efficiency, the composite doped with lithium may be excessively oxidized by oxygen; thus, it is preferable to use at least one of lithium hydride (LiH), lithium nitride (Li3N), and lithium metal that does not contain oxygen as the lithium source used in step 1-3.

The amount of the lithium source used may be selected such that the content of lithium contained in the silicon-carbon composite is 1% by weight to 6% by weight based on the total weight of the silicon-carbon composite.

For example, the content of the lithium source may be 1 to 6% by weight based on the total weight of the silicon composite oxide comprising the first carbon layer and the lithium source.

When the mixing weight ratio of the silicon composite oxide comprising the first carbon layer and the lithium source satisfies the above range, an appropriate content of lithium in the silicon-carbon composite may be achieved, whereby it may be more advantageous for achieving the effect desired in the present invention.

The mixing may be carried out by sufficiently mixing the silicon composite oxide comprising the first carbon layer and the lithium source under an inert atmosphere using argon (Ar) gas, nitrogen (N₂) gas, or a mixed gas thereof, sealing, and stirring for homogenization.

Meanwhile, the mixing may be carried out in the presence of a solvent.

The solvent may comprise at least one selected from carbonates such as dibutyl carbonate, lactones, sulfolanes, ethers, and aromatic or alicyclic hydrocarbons.

When the silicon composite oxide comprising the first carbon layer and the lithium source are mixed using the solvent, and heating in step 1-4 is carried out as described later, it is possible to further prevent the impact such as decomposition during the charging and discharging of the battery or storage device of a capacitor.

The mixing method may use a dry ball mill, mortar, or revolving mixer, and it may be carried out by, for example, a dry ball mill. When the dry ball mill is used, the mixing ratio (B/P ratio) of balls and powder may be 5:1 to 20:1 by weight, and it may be carried out at a speed of about 20 to 70 rpm for less than about 48 hours.

In addition, the mixing may be carried out as kneading and mixing using a thin-film spin high-speed kneader. For example, it is also possible to knead and mix the powder with lithium metal with a thickness of 0.1 mm or more in the presence of a solvent and then knead and mix again the resultant using a thin-film spin high-speed kneader. In addition, it is preferable to use lithium metal with a thickness of 0.1 mm to 1 mm in light of the speed of doping lithium and productivity.

In the method for preparing a silicon-carbon composite, step 1-4 may comprise heating the lithium-containing mixture in the presence of inert gas to obtain a silicon composite oxide doped with magnesium and lithium (S140).

According to an embodiment of the present invention, a first carbon layer is first formed on the surface of the silicon composite oxide (step 1-2), and step 1-3 and step 1-4 are then performed. As a result, it is possible to solve various conventional problems such as uneven concentration of doped lithium, the problem that the lithium source remains on the surface of the silicon composite oxide, and the problem of deterioration during repeated charging and discharging, while further enhancing the performance of a secondary battery.

In addition, the lithium doping may be carried out using a thermal doping method, and the heating temperature may be adjusted in light of the crystallite size of silicon. In an embodiment, the heating may be carried out in a temperature range of 300° C. to 800° C.

Specifically, the mixture may be calcined by heating at 300° C. to 800° C., preferably, 400° C. to 800° C., more preferably, 550° C. to 800° C., for 30 minutes or longer in the presence of inert gas containing 1,000 ppm or less of oxygen to modify the silicon composite oxide comprising the first carbon layer by lithium doping to obtain a silicon composite doped with lithium. When the heating temperature is equal to, or lower than, the upper limit, the growth of silicon crystals can be suppressed to prevent cycle characteristics from deteriorating. When the heating temperature is equal to, or higher than, the lower limit, a thermally stable silicon composite doped with lithium can be produced. Thus, even when it is applied to an aqueous slurry, initial efficiency can be sufficiently enhanced.

Specifically, lithium can be doped (intercalated) into the silicon composite oxide comprising the first carbon layer by the above heating, and lithium can be diffused into the inside of the silicon composite oxide comprising the first carbon layer.

In addition, more stable heating can be carried out by maintaining the temperature at 300° C. to 700° C. for 30 minutes or longer before the heating.

When lithium doping is carried out using the above thermal doping method, the water resistance and stability to a slurry of a negative electrode active material can be further enhanced.

The inert gas may be argon (Ar) gas, nitrogen (N₂) gas, or a mixture gas thereof containing 1,000 ppm or less, preferably, 50 to 500 ppm, of oxygen.

Upon the heating, the molar ratio of Li/O may be 0.1 to 0.9, preferably, 0.1 to 0.5. The silicon composite oxide may be doped with lithium by the heating to become a silicon composite oxide powder containing magnesium and lithium

As the silicon composite oxide comprising the first carbon layer of steps 1-3 and 1-4 is mixed with a lithium source and heated, at least one selected from Li₂SiO₃ and Li₂Si₂O₅ may be formed. In addition, as the mixing ratio of the silicon composite oxide comprising the first carbon layer and a lithium source is appropriately adjusted, it is possible to adjust it to comprise Li₂Si₂O₅ as a lithium silicon compound upon heating.

In an embodiment, after step 1-4, a step of washing the silicon composite oxide doped with magnesium and lithium may be further carried out.

Some undoped lithium sources may remain inside or on the surface of the silicon composite oxide doped with magnesium and lithium. In order to remove the undoped lithium source that remains from the composite, the silicon composite oxide doped with magnesium and lithium obtained upon heating is sufficiently cooled and then washed with alcohols such as methanol, ethanol, propanol, organic acids such as acetic acid, oxalic acid, lactic acid, inorganic acids such as hydrochloric acid and nitric acid, or pure water. A mixture thereof may also be used. For example, the washing may be carried out by adding it to an aqueous solution of oxalic acid and stirring it.

In the method for preparing a silicon-carbon composite, step 1-5 may comprise forming a second carbon layer on the surface of the silicon composite oxide doped with magnesium and lithium (S150).

According to an embodiment of the present invention, as two or more carbon layers are formed on the surface of the silicon-carbon composite, mechanical properties may be fortified, and side reactions with the electrolyte are suppressed, so that it is possible to enhance the discharge capacity, initial discharge efficiency, and capacity retention rate of a secondary battery.

Specifically, when two or more carbon layers are formed, even if cracks occur on the surface of one of the carbon layers, it is possible to maintain the state in which the carbon layers are electrically connected until the other carbon layer without cracks is completely detached. In addition, the two or more carbon layers, that is, the first carbon layer and the second carbon layer, can produce an effect as a buffer layer.

More specifically, the buffer layer may suppress the deterioration, cracking, and volume expansion of the silicon-carbon composite caused by the mechanical expansion of silicon during discharging.

In addition, as the silicon-carbon composite in which at least two or more carbon layers are sequentially deposited on all, most, or part of the surface of the silicon composite oxide doped with magnesium and lithium is used as a negative electrode active material, it is possible to suppress the release of lithium from the silicon composite oxide doped with magnesium and lithium and to suppress the volume change of silicon particles that occurs during intercalation and detachment of lithium, thereby maintaining high conductivity and conduction path between the particles of the negative electrode active material. As a result, it is possible to provide a negative electrode material for a lithium secondary battery having high charge and discharge capacity and excellent cycle lifespan characteristics and a lithium secondary battery comprising the same. In addition, when an aqueous slurry is prepared, the elution of lithium silicon compound and the infiltration of moisture can be suppressed. As a result, the viscosity change of the slurry and gas generation are suppressed, thereby further enhancing production stability.

Formation of the second carbon layer may be carried out by the same chemical vapor deposition method as step 1-2. For example, the first carbon layer and the second carbon layer may each be formed by CVD of a carbon source.

In addition, the formation of the second carbon layer may be carried out using one or more methods selected from a dry coating method and a liquid coating method.

The type of carbon source that can be used to form the second carbon layer may be selected from the types of carbon sources of the first carbon layer.

According to an embodiment, carbon layers having different film substances may be formed by varying the carbon source and formation conditions used when each layer is formed.

In addition, the formation of the second carbon layer may be carried out at 400° C. to 1,200° C., specifically, 500° C. to 1,100° C., more specifically, 600° C. to 900° C., for 10 minutes to 100 hours, specifically, 30 minutes to 90 hours, more specifically, 50 minutes to 40 hours, by adding an inert gas comprising at least one selected from the group consisting of argon, water vapor, helium, nitrogen, and hydrogen. In such a case, it may be advantageous for controlling the thickness of the second carbon layer to 10 nm to 1,500 nm.

In addition, in order to control the thickness of the second carbon layer, the flow rate of the carbon source and that of the inert gas may be adjusted. For example, the carbon source gas may be supplied at a flow rate of 1 LPM to 50 LPM, specifically, 2 LPM to 40 LPM, more specifically, 3 LPM to 30 LPM, and the inert gas may be supplied at a flow rate of 1 LPM to 50 LPM, specifically, 1 LPM to 40 LPM, more specifically, 2 LPM to 30 LPM.

After the formation of the second carbon layer in step 1-5, a step of pulverizing and classifying the silicon-carbon composite to have an average particle diameter of 2 μm to 15 μm may be further carried out.

The pulverization and classification are as described in step 1-1 above.

According to another embodiment, the method for preparing a silicon-carbon composite comprises step 2-1 of forming a first carbon layer on the surface of a silicon-based powder using chemical vapor deposition; step 2-2 of mixing the silicon-based powder comprising the first carbon layer with a lithium source to obtain a mixture; step 2-3 of calcining the mixture in the presence of inert gas to obtain a composite doped with lithium; and step 2-4 of forming a second carbon layer on the surface of the composite doped with lithium using chemical vapor deposition.

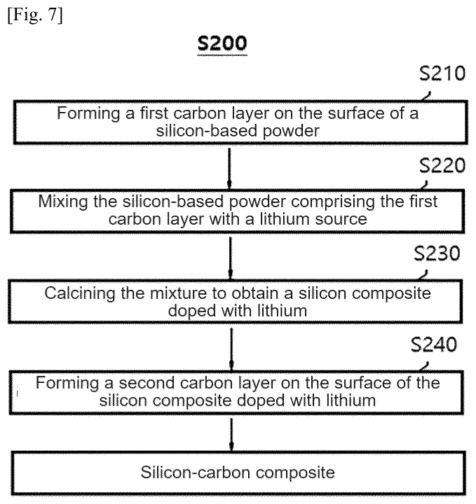

Referring to FIG. 7, in the method for preparing a silicon-carbon composite (S200), step 2-1 may comprise forming a first carbon layer on the surface of a silicon-based powder using chemical vapor deposition (S210).

The types and characteristics of the silicon-based powder are as described above.

In addition, the method of forming the first carbon layer by a chemical vapor deposition method and the amount of carbon (C) contained in the first carbon layer are as described above.

Specifically, the chemical vapor deposition method is a chemical pyrolysis deposition method, which may be carried out by injecting at least one carbon source gas selected from compounds represented by the above Formulae 1 to 3 and carrying out a reaction of the silicon-based powder in a gaseous state at 400° C. to 1,200° C.

The amount of carbon (C) contained in the first carbon layer may be the amount of carbon coating in steps 1-2.

The amount of carbon (C) contained in the first carbon layer may be 0.5% by weight to 15% by weight, preferably, 2% by weight to 15% by weight, more preferably, 3% by weight to 10% by weight, based on the total weight of the silicon-based powder.

When the amount of carbon (C) contained in the first carbon layer satisfies the above range, the surface of the silicon-based powder can be uniformly coated with carbon. This is preferable since cycle lifespan and aqueous slurry stability are further enhanced.

The reaction temperature and reaction time in step 2-1 are as described above.

In the method for preparing a silicon-carbon composite according to an embodiment, it is possible to form a thin and uniform carbon layer comprising, for example, amorphous carbon, crystalline carbon, graphene, reduced graphene oxide, a carbon nanotube, a carbon nanofiber, or graphite as a main component on the surface of the silicon-based powder even at a relatively low temperature through a gas-phase reaction of the carbon source gas. In addition, the detachment reaction in the carbon layer thus formed does not substantially take place.

In addition, when a carbon layer is uniformly formed over the entire surface of the silicon-based powder through the gas-phase reaction, a carbon film (first carbon layer) having high crystallinity can be formed.

According to an embodiment of the present invention, when a reaction gas comprising the carbon source gas and an inert gas is supplied to the silicon-based powder, the reaction gas may form a carbon layer comprising at least one selected from amorphous carbon, crystalline carbon, graphene, reduced graphene oxide, a carbon nanotube, a carbon nanofiber, and graphite on the surface of the silicon-based powder. For example, as the reaction time elapses, the conductive carbon material deposited on the surface of the silicon-based powder is gradually grown to obtain a silicon-based powder comprising a first carbon layer.

The specific surface area of the silicon-carbon composite according to an embodiment of the present invention may decrease according to the amount of carbon coating.

In addition, according to an embodiment of the present invention, by virtue of the formation of the first carbon layer of the silicon-carbon composite, it is possible to suppress structural collapse due to the volume expansion of silicon particles and silicon oxide even if a binder is not used; and to provide an electrode and a lithium secondary battery having excellent electrical conductivity and capacity characteristics by minimizing an increase in resistance.

In addition, one or more of the silicon-based powders may be connected to each other to form an aggregate. Thus, in order to prevent the formation of such aggregates, after the first carbon layer is formed in step 2-1, a step of pulverization and classification may be further carried out such that the final silicon-carbon composite may have an average particle diameter of 2 μm to 15 μm. The pulverization and classification method is as described above.

In the method for preparing a silicon-carbon composite, step 2-2 may comprise mixing the silicon-based powder comprising the first carbon layer with a lithium source to obtain a mixture (S120).

The type of the lithium source is as described above.

The amount of the lithium source used may be selected such that the content of lithium contained in the silicon-carbon composite is 2% by weight to 10% by weight based on the total weight of the silicon-carbon composite.

For example, the content of the lithium source may be 6 to 10% by weight based on the total weight of the silicon-based powder comprising the first carbon layer and the lithium source.

When the mixing weight ratio of the silicon-based powder comprising the first carbon layer and the lithium source satisfies the above range, an appropriate content of lithium in the silicon-carbon composite may be achieved, whereby it may be more advantageous for achieving the effect desired in the present invention.

The mixing may be carried out by sufficiently mixing the silicon-based powder comprising the first carbon layer and the lithium source under an inert atmosphere using argon (Ar) gas, nitrogen (N₂) gas, or a mixed gas thereof, sealing, and stirring for homogenization.

Meanwhile, the mixing may be carried out in the presence of a solvent.

The type of the solvent is as described above.

When the silicon-based powder comprising the first carbon layer and the lithium source are mixed using the solvent, and calcination in step 2-3 is carried out as described later, it is possible to further prevent the impact such as decomposition during the charging and discharging of the battery or storage device of a capacitor.

The mixing method is as described above.

In the method for preparing a silicon-carbon composite, step 2-3 may comprise calcining the mixture obtained in step 2-2 in the presence of inert gas comprising 1,000 ppm or less of oxygen to obtain a lithium-doped silicon composite (S130).

According to an embodiment of the present invention, a first carbon layer is first formed on the surface of the silicon-based powder (step 2-2), and step 2-2 and step 2-3 are then performed. As a result, it is possible to solve various conventional problems such as uneven concentration of doped lithium, the problem that the lithium source remains on the surface of the silicon composite oxide, and the problem of deterioration during repeated charging and discharging, while further enhancing the performance of a secondary battery.

In addition, the lithium doping may be carried out using a thermal doping method, and the calcination temperature may be adjusted in light of the crystallite size of silicon.

Specifically, the mixture may be calcined by heating at 300° C. to 800° C., preferably, 400° C. to 800° C., more preferably, 550° C. to 800° C., for 30 minutes or longer in the presence of inert gas containing 1,000 ppm or less of oxygen to modify the silicon-based powder comprising the first carbon layer by lithium doping to obtain a silicon composite doped with lithium. When the calcination temperature is equal to, or lower than, the upper limit, the growth of silicon crystals can be suppressed to prevent cycle characteristics from deteriorating. When the calcination temperature is equal to, or higher than, the lower limit, a thermally stable silicon composite doped with lithium can be produced. Thus, even when applied to an aqueous slurry, initial efficiency can be sufficiently enhanced.

Specifically, lithium can be doped (intercalated) into the silicon-based powder comprising the first carbon layer by the above calcination, and lithium can be diffused into the inside of the silicon-based powder comprising the first carbon layer.

In addition, more stable calcination can be carried out by maintaining the temperature at 300°° C. to 700°° C. for 30 minutes or longer before the calcination.

When lithium doping is carried out using the above thermal doping method, the water resistance and stability to a slurry of a negative electrode active material can be further enhanced.

The type of the inert gas is as described above.

Upon the calcination, the molar ratio of Li/O may be 0.1 to 0.9, preferably, 0.1 to 0.5. The calcination allows a silicon-based powder, such as a SiOₓ powder to be doped with lithium to prepare a lithium-containing SiOₓ powder.

In addition, some undoped lithium sources may remain inside or on the surface of the silicon composite doped with lithium. In order to remove the undoped lithium source that remains from the composite, the silicon composite obtained upon calcination is sufficiently cooled and then washed with alcohols, alkaline water, weak acids, or pure water

As the silicon-based powder comprising the first carbon layer of steps 2-2 and 2-3 is mixed with a lithium source and calcined, at least one selected from Li₂SiO₃. Li₂Si₂O₅, and Li₄SiO₄ may be formed. In addition, as the mixing ratio of the silicon-based powder comprising the first carbon layer and a lithium source is appropriately adjusted, it is possible to adjust it to comprise Li₂Si₂O₅ as a lithium silicon compound upon calcination.

In the method for preparing a silicon-carbon composite, step 2-4 may comprise forming a second carbon layer on the surface of the silicon composite doped with lithium using chemical vapor deposition.

According to an embodiment of the present invention, as two or more carbon layers are formed on the surface of the silicon-carbon composite, mechanical properties may be fortified, and side reactions with the electrolyte are suppressed, so that it is possible to enhance the discharge capacity, initial discharge efficiency, and capacity retention rate of a secondary battery.

Specifically, when two or more carbon layers are formed, even if cracks occur on the surface of one of the carbon layers, it is possible to maintain the state in which the carbon layers are electrically connected until the other carbon layer without cracks is completely detached. In addition, the two or more carbon layers, that is, the first carbon layer and the second carbon layer, can produce an effect as a buffer layer.

In addition, as a silicon-carbon composite in which at least two or more carbon layers are sequentially deposited on all, most, or part of the surface of the silicon composite oxide is used as a negative electrode active material, it is possible to suppress the release of lithium from the silicon composite oxide and to suppress the volume change of silicon particles that occurs during intercalation and detachment of lithium, thereby maintaining high conductivity and conduction path between the particles of the negative electrode active material. As a result, it is possible to provide a negative electrode material for a lithium secondary battery having high charge and discharge capacity and excellent cycle lifespan characteristics and a lithium secondary battery comprising the same. In addition, when an aqueous slurry is prepared, the elution of lithium silicon compound and the infiltration of moisture can be suppressed. As a result, the viscosity change of the slurry and gas generation are suppressed, thereby further enhancing production stability.

Formation of the second carbon layer may be carried out by the same chemical vapor deposition method as step 2-1. For example, the first carbon layer and the second carbon layer may each be formed by CVD of a carbon source.

In addition, the formation of the second carbon layer may be carried out using one or more methods selected from a dry coating method and a liquid coating method.

The type of carbon source that can be used to form the second carbon layer may be selected from the types of carbon sources of the first carbon layer.

According to an embodiment, carbon layers having different film substances may be formed by varying the carbon source and formation conditions used when each layer is formed.

The method of forming the second carbon layer and the thickness of the second carbon layer formed thereby are as described above.

After the formation of the second carbon layer in step 2-4, a step of pulverizing and classifying the silicon-carbon composite to have an average particle diameter of 2 μm to 15 μm.

The pulverization and classification is as described above.

### Negative Electrode Active Material

The negative electrode active material according to an embodiment of the present invention may comprise the silicon-carbon composite.

The negative electrode active material may further comprise a carbon-based negative electrode material.

The negative electrode active material may further comprise a silicon composite.

The negative electrode active material may be used as a mixture of the silicon-carbon composite, the carbon-based negative electrode material, and the silicon composite. In such an event, the electrical resistance of the negative electrode active material can be reduced, while the expansion stress involved in charging can be relieved at the same time.

The carbon-based negative electrode material may comprise, for example, at least one selected from the group consisting of natural graphite, synthetic graphite, soft carbon, hard carbon, mesocarbon, a carbon fiber, a carbon nanotube, pyrolytic carbon, coke, a glass carbon fiber, a sintered organic high molecular compound, and carbon black.

The carbon-based negative electrode material, for example, a graphite-based negative electrode material may be employed in an amount of 30% by weight to 95% by weight, more specifically, 30% by weight to 90% by weight, based on the total weight of the negative electrode active material.

In addition, if silicon particles having a crystallite size of 15 nm or less are used as mixed with graphite-based materials generally having low volume expansion, only the silicon particles do not cause large volume expansion; thus, a secondary battery with excellent cycling characteristics can be obtained since the separation between the graphite material and the silicon particles hardly takes place.

### Secondary Battery

According to an embodiment of the present invention, there is provided a negative electrode comprising the negative electrode active material and a secondary battery comprising the same.

The secondary battery may comprise a positive electrode, a negative electrode, a separator interposed between the positive electrode and the negative electrode, and a non-aqueous liquid electrolyte in which a lithium salt is dissolved, wherein the negative electrode may comprise a negative electrode active material comprising the silicon-carbon composite.

The negative electrode may be composed of a negative electrode mixture only or may be composed of a negative electrode current collector and a negative electrode mixture layer (negative electrode active material layer) supported thereon. Similarly, the positive electrode may be composed of a positive electrode mixture only or may be composed of a positive electrode current collector and a positive electrode mixture layer (positive electrode active material layer) supported thereon. In addition, the negative electrode mixture and the positive electrode mixture may each further comprise a conductive agent and a binder.

Materials known in the art may be used as a material constituting the negative electrode current collector and a material constituting the positive electrode current collector. Materials known in the art may be used as a binder and a conductive material added to the negative electrode and the positive electrode.

If the negative electrode is composed of a current collector and an active material layer supported thereon, the negative electrode may be prepared by coating the negative electrode active material composition comprising the silicon-carbon composite on the surface of the current collector and drying it.

In addition, the secondary battery comprises a non-aqueous liquid electrolyte in which the non-aqueous liquid electrolyte may comprise a non-aqueous solvent and a lithium salt dissolved in the non-aqueous solvent.

A solvent commonly used in the field may be used as a non-aqueous solvent. Specifically, an aprotic organic solvent may be used.

Examples of the aprotic organic solvent include cyclic carbonates such as ethylene carbonate, propylene carbonate, and butylene carbonate, cyclic carboxylic acid esters such as furanone, chain carbonates such as diethyl carbonate, ethylmethyl carbonate, and dimethyl carbonate, chain ethers such as 1,2-methoxyethane, 1,2-ethoxyethane, and ethoxymethoxyethane, and cyclic ethers such as tetrahydrofuran and 2-methyltetrahydrofuran. They may be used alone or in combination of two or more.

The secondary battery may comprise a non-aqueous secondary battery.

The negative electrode active material and the secondary battery using the silicon-carbon composite can enhance initial charge and discharge efficiency, cycle characteristics, rapid charge and discharge characteristics, and capacity per weight and enhance charge and discharge capacity, as well as initial charge and discharge efficiency and capacity maintenance rate at the same time.

### Mode for the Invention

Hereinafter, the present invention will be described in detail with reference to examples. The following examples are only illustrative of the present invention, and the scope of the present invention is not limited thereto.

### EXAMPLE

### Example 1-1

Preparation of a Silicon-Carbon composite

Step 1-1 and step 1-2: As a silicon oxide-based powder doped with 7 to 8% by weight of Mg, 6 kg of a silicon composite oxide powder with an average particle diameter of about 6 μm and a BET specific surface area of about 5 to 7 m²/g was charged into a graphite crucible, it was left in a thermal treatment furnace. While argon gas was supplied into the treatment furnace at a flow rate of 10 LPM (1/minute), the temperature was raised to about 900° C. at a temperature elevation rate of 500° C./hr. Upon completion of the temperature elevation, the flow rate of argon gas was changed to 2 LPM, and methane gas was supplied at a flow rate of 8 LPM, which was maintained for about 7 hours. Thereafter, argon gas was supplied at a flow rate of 10 LPM for natural cooling, and the powder was recovered after reaching room temperature to obtain a silicon composite oxide powder (C-DMSO powder) comprising a first carbon layer.

Step 1-3: In a glove box substituted with argon, 970 g of the silicon composite oxide powder comprising a first carbon layer and 30 g of a LiH powder were placed in a sealable alumina ball mill reactor, filled with zirconia balls, and sealed to prevent air from entering. Thereafter, the ball mill reactor was maintained at a speed of 50 rpm for about 24 hours, and the powder was then recovered in the glove box to obtain a lithium-containing mixture.

Step 1-4: The lithium-containing mixture was placed in a crucible and left in a thermal treatment furnace. The temperature was raised to about 650° C. in the presence of argon gas, and it was then heated for about 12 hours to obtain a silicon composite oxide doped with magnesium and lithium.

Step 1-5: The silicon-lithium composite oxide doped with magnesium and lithium was added to an aqueous solution of 0.1 M oxalic acid and stirred for 2 hours to remove residual lithium on the surface. In such an event, it was carried out at a weight ratio of solution and powder of 10:1. The silicon composite oxide doped with magnesium and lithium and dried was charged into a treatment furnace, and the internal atmosphere was depressurized using a vacuum pump. The pressure at this time was −100 kPa. Thereafter, ethylene gas was supplied to maintain the pressure at 40 kPa. Then, the gas supply was stopped, and the temperature was raised to 650° C. at a temperature elevation rate of 10° C./minute. Upon completion of the temperature elevation, ethylene gas was supplied at a flow rate of 3 LPM at atmospheric pressure for 6 hours, and the gas supply was then stopped. Natural cooling was performed in an argon gas atmosphere, and the powder was recovered after reaching room temperature and subjected to 400-mesh filtration to prepare a silicon-carbon composite in which a second carbon layer was formed on the surface of the silicon composite oxide doped with magnesium and lithium.

### Fabrication of a Secondary Battery

A negative electrode and a battery (coin cell) comprising the silicon-carbon composite as a negative electrode active material were each prepared.

The negative electrode active material, Super-P as a conductive material, and polyacrylic acid were mixed at a weight ratio of 80:10:10 with water to prepare a negative electrode active material composition having a solids content of 45%.

The negative electrode active material composition was applied to a copper foil having a thickness of 18 μm and dried to prepare an electrode having a thickness of 43 um. The copper foil coated with the electrode was punched in a circular shape having a diameter of 14 mm to prepare a negative electrode plate for a coin cell.

Meanwhile, a metallic lithium foil having a thickness of 0.3 mm was used as a positive electrode plate.

A porous polyethylene sheet having a thickness of 25 μm was used as a separator. An electrolyte solution in which LiPF₆ had been dissolved at a concentration of 1 M in a mixed solvent of ethylene carbonate (EC) and ethyl methyl carbonate (EMC) at a volume ratio of 3:7, and 1.5% by weight of vinylene carbonate and 0.5% by weight of 1,3-propane sultone as an additive had been dissolved, was used as an electrolyte. The above components were employed to fabricate a coin cell (battery) having a thickness of 3.2 mm and a diameter of 20 mm (CR2032 type).

### Example 1-2

A silicon-carbon composite and a secondary battery were each prepared in the same manner as in Example 1-1, except that, in step 1-1 and step 1-2 of Example 1-1, a silicon oxide-based powder doped with 5 to 6% by weight of Mg was used; in step 1-3, 950 g of the silicon composite oxide powder (C-DMSO powder) and 30 g of a LiH powder were used; and, in step 1-5, upon completion of the temperature elevation, ethylene gas was supplied at a flow rate of 3 LPM and maintained for 4 hours.

### Example 1-3

A silicon-carbon composite and a secondary battery were each prepared in the same manner as in Example 1-1, except that, in step 1-1 and step 1-2 of Example 1-1, a silicon oxide-based powder doped with 8 to 9% by weight of Mg was used; and, in step 1-5, after the silicon composite oxide was charged into a treatment furnace, the temperature was raised to 640° C. at a rate of 10° C./minute in an argon atmosphere, ethylene gas was then supplied at a flow rate of 3 LPM and maintained for 5 hours.

### Example 1-4

A silicon-carbon composite and a secondary battery were each prepared in the same manner as in Example 1-1, except that, in step 1-1 and step 1-2 of Example 1-1, a silicon oxide-based powder doped with 12 to 13% by weight of Mg was used; and, in step 1-3, 950 g of the silicon composite oxide powder (C-DMSO powder) and 40 g of a LiH powder were used.

### Example 1-5

A silicon-carbon composite and a secondary battery were each prepared in the same manner as in Example 1-1, except that, in step 1-5, upon completion of the temperature elevation, ethylene gas was then supplied at a flow rate of 3 LPM and maintained for 2 hours.

### Example 2-1

### Preparation of a Silicon-Carbon Composite

Step 2-1: As a silicon-based powder, 6 kg of a silicon oxide powder (SiOₓ, x=1.01; Daejoo Electronic Materials) with an average particle diameter of about 6 μm and a BET specific surface area of about 2.5 m²/g was charged into a graphite crucible, it was left in a treatment furnace (medium-sized furnace) capable of maintaining an atmosphere. While argon gas was supplied into the treatment furnace at a flow rate of 10 LPM, the temperature was raised to about 700° C. at a temperature elevation rate of 500° C./hr. Upon completion of the temperature elevation, the flow rate of argon gas was changed to 7 LPM (l/minute), and ethylene gas was supplied at a flow rate of 3 LPM, which was maintained for about 12 hours. Thereafter, argon gas was supplied at 10 LPM for natural cooling, and the powder was recovered after reaching room temperature to obtain a silicon-based powder (C—SiOₓ powder) comprising a first carbon layer.

Step 2-2: In a glove box substituted with argon, 180 g of the silicon-based powder comprising a first carbon layer (C—SiOₓ powder) obtained in step 2-1 and 20 g of a LiH powder (30 mesh) were placed in a sealable alumina ball mill reactor, filled with zirconia balls, and sealed to prevent air from entering. Thereafter, the ball mill reactor was maintained at a speed of 50 rpm for about 24 hours, and the powder was then recovered in the glove box to obtain a mixture.

Step 2-3: The mixture was classified using a 400-mesh sieve, and the classified sample was placed in an alumina crucible and left in a treatment furnace (small-size furnace) capable of maintaining an atmosphere. The temperature was raised to about 650° C. in the presence of argon gas at a temperature elevation rate of 250° C./hr, and it was then calcined for about 12 hours to obtain a silicon-based composite doped with lithium.

Step 2-4: The silicon-based composite doped with lithium was charged into a treatment furnace, argon gas was supplied to the treatment furnace to replace the treatment furnace with argon, and the temperature was raised to 650° C. at a temperature elevation rate of 250° C./hr while argon gas was supplied at a flow rate of 7 LPM (1/minute). Upon completion of the temperature elevation, it was maintained for about 6 hours. Subsequently, the gas supply was changed to 7 LPM (1/minute) of argon gas and 3 LPM (1/minute) of ethylene gas, which was maintained for 2 hours. Upon completion of the maintenance, natural cooling was performed, and the powder was recovered after reaching room temperature to obtain a silicon-carbon composite in which a second carbon layer was formed.

### Fabrication of a Secondary Battery

A negative electrode and a battery (coin cell) comprising the silicon-carbon composite as a negative electrode active material were each prepared.

The negative electrode active material, Super-P as a conductive material, and polyacrylic acid were mixed at a weight ratio of 80:10:10 with water to prepare a negative electrode active material composition having a solids content of 45%.

The negative electrode active material composition was applied to a copper foil having a thickness of 18 μm and dried to prepare an electrode having a thickness of 70 um. The copper foil coated with the electrode was punched in a circular shape having a diameter of 14 mm to prepare a negative electrode plate for a coin cell.

Meanwhile, a metallic lithium foil having a thickness of 0.3 mm was used as a positive electrode plate.

A porous polyethylene sheet having a thickness of 25 μm was used as a separator. A liquid electrolyte in which LiPF₆ had been dissolved at a concentration of 1 M in a mixed solvent of ethylene carbonate (EC) and diethylene carbonate (DEC) at a volume ratio of 1:1 was used as an electrolyte. The above components were employed to fabricate a coin cell (battery) having a thickness of 3.2 mm and a diameter of 20 mm (CR2032 type).

### Example 2-2

A silicon-carbon composite and a secondary battery were each prepared in the same manner as in Example 2-1, except that, in step 2-1 of Example 1-1, upon completion of the temperature elevation, a gas supply was maintained for about 12 hours at 7 LPM of argon gas and 3 LPM of ethylene gas; and, in step 2-4, upon completion of the temperature elevation, it was maintained for about 6 hours, and, subsequently, the gas supply was changed to 7 LPM (1/minute) of argon gas and 4 LPM (1/minute) of ethylene gas, which was maintained for about 6 hours.

### Example 2-3

A silicon-carbon composite and a secondary battery were each prepared in the same manner as in Example 2-1, except that, in step 2-1 of Example 1-1, upon completion of the temperature elevation, a gas supply was maintained for about 12 hours at 7 LPM of argon gas and 6 LPM of methane gas; and, in step 2-4, upon completion of the temperature elevation, it was maintained for about 6 hours, and, subsequently, the gas supply was changed to 2 LPM of argon gas and 8 LPM of ethylene gas, which was maintained for about 12 hours.

### Comparative Example 1-1

A silicon-carbon composite and a secondary battery were each prepared in the same manner as in Example 1-1, except that, in step 1-5 of Example 1-1, a second carbon layer was not formed.

### Comparative Example 1-2

A silicon-carbon composite and a secondary battery were each prepared in the same manner as in Example 1-1, except that, in step 1-1 and step 1-2 of Example 1-1, a silicon oxide powder without Mg was used; in step 1-3, 950 g of the silicon oxide powder and 100 g of a LiH powder were used; and, in step 1-5, a second carbon layer was not formed.

### Comparative Example 1-3

A silicon-carbon composite and a secondary battery were each prepared in the same manner as in Example 1-1, except that step 1-3 of Example 1-1 was not performed; and, in step 1-4, a silicon composite oxide doped with magnesium was obtained.

### Comparative Example 1-4

A SiO powder produced by a precipitation method and then pulverized was coated with carbon at 850° C. through thermal chemical vapor deposition (CVD) using a mixed gas of argon and propane as a carbon source. The SiO powder coated with carbon was mixed with lithium hydride as a source of Li at a Li/O molar ratio of 0.37. The temperature was raised at a rate of 300° C./hr, and it was heated at 600° C. for 24 hours to perform Li doping. It was mixed with a magnesium hydride powder as a source of Mg at a Mg/O molar ratio of 0.03. The temperature was raised at a rate of 300° C./hr, and it was heated at 600° C. for 24 hours to perform Mg doping to obtain a silicon-carbon composite. Thereafter, a secondary battery was prepared in the same manner as in Example 1-1.

### Comparative Example 2-1

A silicon-carbon composite and a secondary battery were each prepared in the same manner as in Example 2-1, except that, in step 2-1 of Example 2-1, a gas supply was maintained at about 600° C. for about 4 hours at 7 LPM of argon gas and 2 LPM of ethylene gas.

### Comparative Example 2-2

A silicon-carbon composite and a secondary battery were each prepared in the same manner as in Example 2-1, except that, in step 2-1 of Example 2-1, a gas supply was maintained at about 950° C. for about 1 hour at 7 LPM of argon gas and 2 LPM of methane gas.

### Comparative Example 2-3

A silicon-carbon composite and a secondary battery were each prepared in the same manner as in Example 2-1, except that, step 2-4 of Example 2-1 was not formed.

### TEST EXAMPLE

### <Test Example 1> Analysis of the Content of the Component Elements in the Silicon-Carbon Composite

In the silicon-carbon composites prepared in the Examples and Comparative Examples, the amount of carbon (C) in the first carbon layer, and the content of each of total carbon (C), oxygen (O), lithium (Li), and magnesium (Mg) in the composite based on the total weight of the silicon-carbon composite were analyzed. The content of each element was analyzed by an elemental analyzer and inductively coupled plasma (ICP) emission spectroscopy.

### <Test Example 2> Analysis of the Molar Ratio of the Component Elements in the Silicon-Carbon Composite

In the silicon-carbon composites prepared in the Examples and Comparative Examples, the molar ratio of the Li element to the Si element and the molar ratio of the Mg element to the Si element were calculated from the contents of each element measured in Test Example 1.

### <Test Example 3> Analysis of the Thicknesses of the Carbon Layers in the Silicon-Carbon Composite

In the silicon-carbon composites prepared in the Examples and Comparative Examples, the thicknesses of the first carbon layer and the second carbon layer were measured.

The sample for measurement was processed from the surface (porous layer surface) of the measurement sample in the depth direction (direction toward the inside of the measurement sample) using focused ion beam (FIB) equipment to create a processed surface (cross-section). The processed surface obtained was analyzed using a scanning transmission electron microscope (STEM) equipment of JEM-ARM200F from JEOL.

### <Test Example 4> Analysis of the Crystallite Size of Silicon Particles

In the silicon-carbon composite, silicon particles were subjected to an X-ray diffraction (Cu-Kα) analysis using copper as a cathode target to calculate the crystallite size of the silicon particles by the Scherrer equation based on a full width at half maximum (FWHM) of the diffraction peak of Si (220) around 2θ=47.5°.

### <Test Example 5> ph of the Silicon-Carbon Composite

About 10 g of each silicon-carbon composite was added to about 200 mL of secondary pure water and stirred for 1 hour. Sonication was performed three times for 1 minute each. The filtrate was measured using a pH meter (HM-30P Model from TOADKK) for the pH of the silicon-carbon composite.

<Test Example 6> Specific gravity of the silicon-carbon composite

For the specific gravity (particle density) of each silicon-carbon composite, Acupick II1340 manufactured by Shimadzu Corporation was used, and the measurement was carried out after 200 times of purge with helium gas in a sample holder set at a temperature of 23° C.

### <Test Example 7> Evaluation of Slurry Stability

Each of the silicon-carbon composites prepared in the Examples and Comparative Examples was used as a negative electrode active material. The negative electrode active material, a conductive material (carbon black), a binder (CMC/SBR), zirconia balls, and water were mixed at a weight ratio of 47:0.5:1.5:6:45 using a revolving mixer to prepare a slurry. The slurry was diluted in water and dispersed using an ultrasonic disperser, and the pH was then measured to evaluate the slurry stability.

The slurry stability was evaluated as follows based on the degree of gas generation:
Very excellent: no gas was generated after 7 days at 40° C.
Excellent: no gas was generated after 7 days at room temperature
Poor: gas was generated within 1 day at room temperature
Very poor: gas was generated within 1 hour at room temperature

In addition, the slurry stability was evaluated as follows:
○: no gas generation and no change in viscosity
×: gas generation was visually observed, and the slurry was gelated after 48 hours

### <Test Example 8> Measurement of Discharge Capacity and Initial Charge and Discharge Efficiency of the Secondary Battery

The coin cells (secondary batteries) prepared in the Examples and Comparative Examples were each charged at a constant current of 0.1 C until the voltage reached 0.005 V and discharged at a constant current of 0.1 C until the voltage reached 2.0 V to measure the charge capacity (mAh/g), discharge capacity (mAh/g), and initial charge and discharge efficiency (%). The results are shown in Tables 1 and 2 below.

$$Initial charge and discharge efficiency ( \% ) = discharge capacity / charge capacity \times 100 \qquad [ Equation l ]$$

### <Test Example 9> X-Ray Diffraction Analysis

The crystal structure of the silicon-carbon composites prepared in the Examples was analyzed with an X-ray diffraction analyzer (X′Pert3 of Malvern Panalytical).

Specifically, the applied voltage was 40 kV, and the applied current was 40 mA. The range of 20 was 10° to 80°, and it was measured by scanning at an interval of 0.05°.

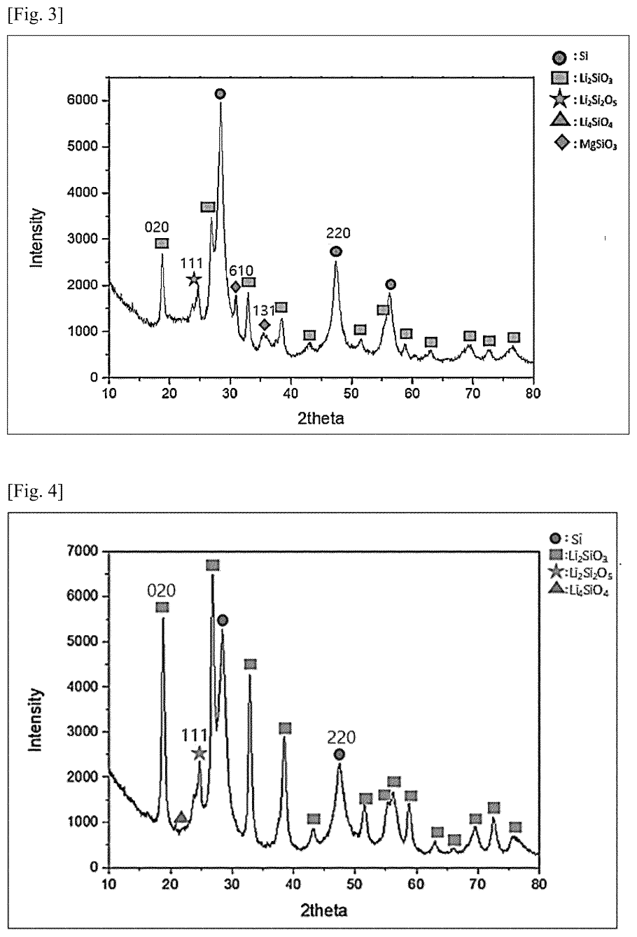

FIG. 3 shows the measurement results of an X-ray diffraction analysis of the silicon-carbon composite of Example 1-1.

Referring to FIG. 3, as can be seen from the X-ray diffraction pattern, the silicon-carbon composite of Example 1-1 had a peak accounting for Si (Si (220)) at a diffraction angle (2θ) of about 46.5 to 48.0°, a peak accounting for Li₂SiO₃ (Li₂SiO₃ (020)) at a diffraction angle (2θ) of about 18.0 to 19.5°, and a peak accounting for Li₂Si₂O₅ (Li₂Si₂O₅ (111)) at a diffraction angle (2θ) of about 23.8 to 25.8°.

Meanwhile, FIG. 4 shows the measurement results of an X-ray diffraction analysis of the silicon-carbon composite of Example 2-1.

Referring to FIG. 4, as can be seen from the X-ray diffraction pattern, the silicon-carbon composite of Example 2-1 had a peak accounting for Si (Si (220)) at a diffraction angle (2θ) of about 46.5 to 48.0°, a peak accounting for Li₂SiO₃ (Li₂SiO₃ (020)) at a diffraction angle (2θ) of about 18.0 to 19.5°, and a peak accounting for Li₂Si₂O₅ (Li₂Si₂O₅ (111)) at a diffraction angle (2θ) of about 23.8 to 25.8°.

### <Test Example 10> Raman Spectroscopic Analysis

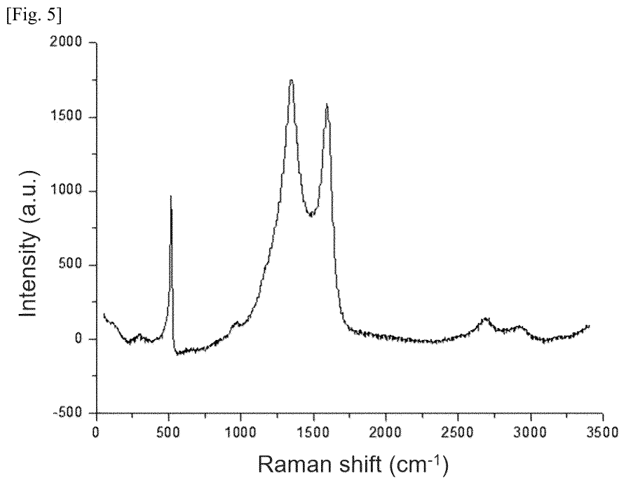

The silicon-carbon composite prepared in Example 2-1 was subjected to a Raman spectroscopic analysis. Raman analysis was carried out using a micro-Raman analyzer (Renishaw, RM1000-In Via) at 2.41 eV (514 nm). The results are shown in FIG. 5.

As can be seen from FIG. 5, the presence of a carbon layer could be confirmed in the Raman spectrum obtained by Raman spectroscopic analysis.

TABLE 1

| | | | | | | | Thickness | C content |
|---|---|---|---|---|---|---|---|---|
| | Li | Mg | | | 1^{st} carbon layer | | of the 2^{nd} | in the |
| | content | content | Molar ratio | Molar ratio | Thickness | C content | carbon layer | composite |
| No. | (wt. %) | (wt. %) | Li/Si (x) | Mg/Si (x) | (nm) | (wt. %) | (nm) | (wt. %) |
| Ex. 1-1 | 2.0 | 7.3 | 0.13 | 0.14 | 50 | 3.0 | 200 | 13.0 |
| Ex. 1-2 | 2.5 | 5.4 | 0.17 | 0.11 | 50 | 3.0 | 50 | 6.7 |
| Ex. 1-3 | 2.0 | 8.7 | 0.13 | 0.16 | 50 | 3.0 | 60 | 5.8 |
| Ex. 1-4 | 4.0 | 13.0 | 0.28 | 0.27 | 50 | 4.0 | 150 | 11.0 |
| Ex. 1-5 | 2.0 | 7.3 | 0.13 | 0.14 | 50 | 3.0 | 10 | 4.5 |
| C. Ex. 1-1 | 2.0 | 7.3 | 0.13 | 0.14 | 50 | 3.0 | x | 3.0 |
| C. Ex. 1-2 | 8.0 | 0.0 | 0.54 | 0.0 | 50 | 3.0 | x | 3.0 |
| C. Ex. 1-3 | 0.0 | 8.0 | 0.0 | 0.17 | 50 | 3.0 | 50 | 4.5 |
| C. Ex. 1-4 | 7.4 | 5.3 | 0.50 | 0.10 | 50 | 3.0 | x | 3.0 |

| | Crystallite size | | | | Initial charge |
|---|---|---|---|---|---|
| | of silicon | | Specific | | and discharge |
| No. | particles (nm) | pH | gravity | Slurry stability | efficiency (%) |
| Ex. 1-1 | 8.3 | 10.9 | 2.45 | Very excellent | 87.5 |
| Ex. 1-2 | 5.2 | 10.9 | 2.46 | Excellent | 86.5 |
| Ex. 1-3 | 8.6 | 10.9 | 2.46 | Very excellent | 88.4 |
| Ex. 1-4 | 9.1 | 10.9 | 2.51 | Excellent | 89.2 |
| Ex. 1-5 | 7.2 | 10.9 | 2.53 | Excellent | 87.2 |
| C. Ex. 1-1 | 8.5 | 11.9 | 2.53 | Poor | 87.1 |
| C. Ex. 1-2 | 6.3 | 12.5 | 2.43 | Very poor | 90.1 |
| C. Ex. 1-3 | 7.3 | 9.5 | 2.55 | Very excellent | 82.0 |
| C. Ex. 1-4 | 9.7 | 13.2 | 2.57 | Very poor | 82.0 |

As can be seen from Table 1 above, the secondary batteries, in which the silicon-carbon composites of Examples 1-1 to 1-5, each comprising silicon particles, silicon oxide, magnesium silicate, a lithium silicon compound, and carbon, along with two or more carbon layers, was used as a negative electrode active material were excellent in both slurry stability and initial charge and discharge efficiency as compared with the secondary batteries of Comparative Examples 1-1 to 1-4. Specifically, in the negative electrode active materials of Examples 1-1 to 1-5, the slurry stability was excellent, and the initial charge and discharge efficiency was excellent, ranging from 86.5% to 89.2%.

In contrast, in the secondary batteries of Comparative Examples 1-1, 1-2, and 1-4, in which a single-layer silicon-carbon composite without a second carbon layer was used, the slurry stability was poor as compared with the secondary batteries of Examples 1-1 to 1-5, and as compared with even the secondary battery of Comparative Example 1-3, and the pH exceeded 11.5.

In addition, in the secondary battery of Comparative Examples 1-3, in which a silicon-carbon composite without a lithium silicon compound was used, the initial charge and discharge efficiency was significantly deteriorated as compared with the secondary batteries of Examples 1-1 to 1-5, and as compared with even the secondary batteries of Comparative Examples 1-1 and 1-2.

Meanwhile, the silicon-carbon composites of Examples 1-1 to 1-5 had a pH of 7.5 to less than 11.5, which was lower than that of the silicon-carbon composites of Comparative Examples 1-1, 1-2, and 1-4. This means that the low pH minimizes the generation of hydrogen gas caused by the reaction between silicon and water, thereby enhancing slurry stability, which was also confirmed in the evaluation of slurry stability.

TABLE 2

| | 1^{st} carbon layer | | Thickness of | C content in | Li content in | Crystallite |
|---|---|---|---|---|---|---|
| | Thickness | C content | the 2^{nd} carbon | the composite | the composite | size of silicon |
| No. | (nm) | (wt. %) | layer (nm) | (wt. %) | (wt. %) | particles (nm) |
| Ex. 2-1 | 50 | 3.0 | 10 | 4.0 | 7.7 | 4.7 |
| Ex. 2-2 | 50 | 3.0 | 50 | 6.3 | 7.6 | 5.6 |
| Ex. 2-3 | 100 | 5.0 | 200 | 15.0 | 8.0 | 5.0 |
| C. Ex. 2-1 | 5 | 3.0 | 10 | 3.9 | 7.8 | 9.0 |
| C. Ex. 2-2 | 2 | 2.0 | 10 | 2.9 | 8.0 | 7.0 |
| C. Ex. 2-3 | 50 | 3.0 | — | 3.0 | 7.5 | 4.7 |

| | | Specific | Slurry | Discharge capacity | Initial charge and |
|---|---|---|---|---|---|
| No. | pH | gravity | stability | (mAh/g) | discharge efficiency (%) |
| Ex. 2-1 | 10.9 | 2.44 | ∘ | 1,250 | 89.8 |
| Ex. 2-2 | 10.5 | 2.43 | ∘ | 1,294 | 88.8 |
| Ex. 2-3 | 10.1 | 2.41 | ∘ | 1,216 | 88.5 |
| C. Ex. 2-1 | 12.7 | 2.49 | x | 1,123 | 78.3 |
| C. Ex. 2-2 | 12.3 | 2.41 | x | 1,187 | 87.4 |
| C. Ex. 2-3 | 11.5 | 2.45 | x | 1,000 | 86.0 |

As can be seen from Table 2 above, the secondary batteries, in which the silicon-carbon composites of Examples 2-1 to 2-3, each comprising silicon particles, silicon oxide, a lithium silicon compound, and carbon, along with two or more carbon layers, in particular, with the thickness of the first carbon layer being 50 nm to 100 nm and the thickness of the second carbon layer being 10 nm to 200 nm, was used as a negative electrode active material were excellent in all of slurry stability, discharge capacity, and initial charge and discharge efficiency of the secondary battery as compared with the secondary batteries of Comparative Examples 2-1 to 2-3.

Specifically, in the negative electrode active materials of Examples 2-1 to 2-3, the slurry stability was excellent, the discharge capacity of the secondary battery was excellent, ranging from 1,216 to 1,294 mAh/g, and the initial charge and discharge efficiency was excellent, ranging from 88.5% to 89.8%.

In contrast, in the secondary batteries of Comparative Examples 2-1 and 2-1, in which the thickness of the first carbon layer was 2 to 5 nm, and the thickness of the second carbon layer was 10 nm, the discharge capacity was 1,123 mAh/g and 1,187 mAh/g, respectively, and the initial charge and discharge efficiency was 78.3% and 87.4%, respectively, which were significantly deteriorated as compared with the secondary batteries of Examples 2-1 to 2-3. Their slurry stability was poor as well.

In addition, in the secondary battery of Comparative Examples 2-3, in which a single-layer silicon-carbon composite without a second carbon layer was used, the discharge capacity was 1,000 mAh/g, and the initial charge and discharge efficiency was 86.0%, which were significantly deteriorated as compared with the secondary batteries of Examples 2-1 to 2-3, and as compared with even the secondary batteries of Comparative Examples 2-1 and 2-2. Its slurry stability was poor as well.

Meanwhile, the silicon-carbon composites of Examples 2-1 to 2-3 had a pH of 10.1 to 10.9, which was lower than that of the silicon-carbon composites of Comparative Examples 2-1 to 2-3, ranging from 11.5 to 12.7. This means that the low pH minimizes the generation of hydrogen gas caused by the reaction between silicon and water, thereby enhancing slurry stability and enhancing initial efficiency and cycle characteristics. The discharge capacity and initial charge and discharge efficiency of the secondary battery attributed thereto could be clearly confirmed in Table 2, as described above.

### Reference Numerals of the Drawings

1: silicon-carbon composite
10: lithium silicon composite oxide
11: silicon particles
12: silicon oxide
13: lithium silicon compound
14: magnesium silicate
21: first carbon layer
22: second carbon layer
20: carbon layers

1. A silicon-carbon composite, which comprises a lithium silicon composite oxide and carbon, wherein the lithium silicon composite oxide comprises silicon particles, silicon oxide, magnesium silicate, and a lithium silicon compound, and the silicon-carbon composite comprises two or more carbon layers comprising a first carbon layer and a second carbon layer.

2. The silicon-carbon composite of claim 1, wherein the ratio of the thickness of the first carbon layer and the thickness of the second carbon layer is 1:0.05 to 200.

3. The silicon-carbon composite of claim 1, wherein the magnesium silicate comprises at least one selected from MgSiO₃ and Mg₂SiO₄.

4. The silicon-carbon composite of claim 1, wherein the total content of magnesium (Mg) contained in the silicon-carbon composite is 3% by weight to 15% by weight based on the total weight of the silicon-carbon composite.

5. The silicon-carbon composite of claim 1, wherein the lithium silicon compound comprises at least one selected from Li₂SiO₃ and Li₂Si₂O₅.

6. The silicon-carbon composite of claim 1, wherein the lithium silicon composite oxide is represented by LiₓMg_{y}SiO_{z} (wherein x, y, and z are positive real numbers), and x, y, and z satisfy the following Relationships (1) to (3):
$$\begin{matrix}0.8 \leq z \leq 1.2 & [ [ … ]\end{matrix} ] \qquad ( 1 )$$
$$\begin{matrix}0.1 \leq x + y \leq 0.8 & [ [ … ] ]\end{matrix} \qquad ( 2 )$$
$$\begin{matrix}0.1 \leq x / y \leq 2 & [ [ … ]\end{matrix} ] . \qquad ( 3 )$$

7. The silicon-carbon composite of claim 1, wherein the total content of lithium (Li) contained in the silicon-carbon composite is 1% by weight to 6% by weight based on the total weight of the silicon-based-carbon composite.

8. A method for preparing the silicon-carbon composite of claim 1, which comprises:
step 1-1 of preparing a silicon composite oxide obtained using a silicon-based raw material and a magnesium-based raw material;
step 1-2 of forming a first carbon layer on the surface of the silicon composite oxide;
step 1-3 of mixing the silicon composite oxide comprising the first carbon layer with a lithium source to obtain a lithium-containing mixture;
step 1-4 of heating the lithium-containing mixture in the presence of inert gas to obtain a silicon composite oxide doped with magnesium and lithium; and
step 1-5 of forming a second carbon layer on the surface of the silicon composite oxide doped with magnesium and lithium.

9. The method for preparing the silicon-carbon composite according to claim 8, which further comprises, after step 1-4, washing the silicon composite oxide doped with magnesium and lithium.

10. A silicon-carbon composite, which comprises a lithium silicon composite oxide and carbon, wherein the lithium silicon composite oxide comprises silicon particles, silicon oxide, and a lithium silicon compound, the silicon-carbon composite comprises two or more carbon layers comprising a first carbon layer and a second carbon layer, the first carbon layer has a thickness of 10 nm to 200 nm, and the second carbon layer has a thickness of 10 nm to 2,000 nm.

11. The silicon-carbon composite of claim 10, wherein the lithium silicon compound comprises at least one selected from Li₂SiO₃, Li₂Si₂O₅, and Li₄SiO₄.

12. The silicon-carbon composite of claim 10, wherein the total content of lithium (Li) contained in the silicon-carbon composite is 2% by weight to 10% by weight based on the total weight of the silicon-carbon composite.

13. The silicon-carbon composite of claim 10, wherein the content of carbon (C) in the silicon-carbon composite is 2% by weight to 30% by weight based on the total weight of the silicon-carbon composite.

14. A method for preparing the silicon-carbon composite of claim 10, which comprises:
step 2-1 of forming a first carbon layer on the surface of a silicon-based powder using chemical vapor deposition;
step 2-2 of mixing the silicon-based powder comprising the first carbon layer with a lithium source to obtain a mixture;
step 2-3 of calcining the mixture in the presence of inert gas to obtain a silicon composite doped with lithium; and
step 2-4 of forming a second carbon layer on the surface of the silicon composite doped with lithium using chemical vapor deposition.

15. The method for preparing the silicon-carbon composite according to claim 14, wherein the calcination in step 2-3 is carried out in the temperature range of 300° C. to 800° C.

16. A negative electrode active material, which comprises the silicon-carbon composite of claim 1.

17. A lithium-ion secondary battery, which comprises the negative electrode material for a lithium-ion secondary battery of claim 16.

18. A negative electrode active material, which comprises the silicon-carbon composite of claim 10.

19. A lithium-ion secondary battery, which comprises the negative electrode material for a lithium-ion secondary battery of claim 18.
